(19) United States
(12) Patent Application Publication
(10) Pub. No.: US 2025/0138443 A1
(43) Pub. Date: May 1, 2025

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: KOJI TAKAHASHI, Chiba (JP); MOTOYA YAMADA, Chiba (JP); SHUBUN KUJIRAI, Kanagawa (JP); YASUO KOJIMA, Chiba (JP)

(21) Appl. No.: 18/921,384

(22) Filed: Oct. 21, 2024

(30) Foreign Application Priority Data
Oct. 25, 2023 (JP) 2023-183415

(51) Int. Cl. G03G 7/00; G03G 5/06; G03G 5/10; G03G 5/147

(52) U.S. Cl. CPC G03G 7/0053; G03G 5/06144; G03G 5/0651; G03G 5/0657; G03G 5/102; G03G 5/14734; G03G 5/14752; G03G 5/14756; G03G 2221/183

(57) ABSTRACT

An electrophotographic photosensitive member includes a support, an undercoat layer formed directly on the support, and a photosensitive layer formed on the undercoat layer, wherein when an ionization potential of the undercoat layer is represented by IPu, the IPu is 6.0 eV or higher, when an ionization potential of the support is represented by IPs, the IPs is lower than the IPu, the undercoat layer contains a compound (α), when an ionization potential of the compound (α) is represented by IPα, the IPα is 5.0 eV or higher and 5.4 eV or lower, and the IPs and the IPα satisfy the following relational expression (1):

$$IPs \geq IP α - 1. . \qquad ( 1 )$$

### BACKGROUND OF THE DISCLOSURE

### Field of the Disclosure

The present disclosure relates to an electrophotographic photosensitive member, and a process cartridge and an electrophotographic apparatus each having the electrophotographic photosensitive member.

### Description of the Related Art

In recent years, an image output from an electrophotographic apparatus is required to have higher image quality and higher stability.

As technologies for solving such problems, there are Japanese Patent Application Laid-Open No. 2020-101652, Japanese Patent Application Laid-Open No. 2020-46640, and Japanese Patent Application Laid-Open No. 2023-115641.

In Japanese Patent Application Laid-Open No. 2020-101652, an electrophotographic photosensitive member is described that contains a specific perinone compound and an amine compound of which the ionization potential in the air is 5.4 eV or higher and 5.9 eV or lower.

In Japanese Patent Application Laid-Open No. 2020-46640, an electrophotographic photosensitive member having an undercoat layer that contains a specific perinone compound and polyurethane is described.

In Japanese Patent Application Laid-Open No. 2023-115641, an electrophotographic photosensitive member is described that contains a triarylamine compound having a reactive group, a curing agent, and an electron transporting material in an undercoat layer, and contains a butyral resin in a specific ratio.

According to studies by the present inventors, it has been found that in the electrophotographic photosensitive members described in Japanese Patent Application Laid-Open No. 2020-101652, Japanese Patent Application Laid-Open No. 2020-46640, and Japanese Patent Application Laid-Open No. 2023-115641, a residual potential is high and there is room for improvement in the fluctuation of a light portion potential.

In addition, it has been found that in some of the electrophotographic photosensitive members described in Japanese Patent Application Laid-Open No. 2023-115641, the residual potential is relatively small, but the fluctuation in the light portion potential becomes relatively large in some cases.

### SUMMARY OF THE DISCLOSURE

An object of the present disclosure is to provide an electrophotographic photosensitive member in which the residual potential is low and the fluctuation of the light portion potential is small.

The present disclosure is an electrophotographic photosensitive member including a support, an undercoat layer formed directly on the support, and a photosensitive layer formed on the undercoat layer, wherein
when an ionization potential of the undercoat layer is represented by IPu, the IPu is 6.0 eV or higher,
when an ionization potential of the support is represented by IPs, the IPs is lower than the IPu,
the undercoat layer contains a compound (a),
when an ionization potential of the compound (a) is represented by IPα, the IPα is 5.0 eV or higher and 5.4 eV or lower, and
the IPs and the IPα satisfy the following relational expression (1):

$$IPs \geq IP α - 1. . \qquad ( 1 )$$

Further features of the present disclosure will become apparent from the following description of exemplary embodiments with reference to the attached drawing.

### BRIEF DESCRIPTION OF THE DRAWINGS

FIG. 1 is a view of one example of an outline configuration of an electrophotographic apparatus having a process cartridge provided with an electrophotographic photosensitive member.

### DESCRIPTION OF THE EMBODIMENTS

Embodiments of the present disclosure will now be described in detail in accordance with the accompanying drawing.

According to the studies by the present inventors, it has been found that the technologies described in Japanese Patent Application Laid-Open No. 2020-101652, Japanese Patent Application Laid-Open No. 2020-46640, and Japanese Patent Application Laid-Open No. 2023-115641, an injection of positive holes from the support to the undercoat layer is small. When electrons are retained in the undercoat layer, the electrons resist being cancelled. Accordingly, the residual potential becomes high, and the fluctuation of the light portion potential becomes large in some cases.

In addition, it has been found that, in some of photosensitive members described in Japanese Patent Application Laid-Open No. 2023-115641, the residual potential is relatively low, but the fluctuation of the light portion potential becomes large in some cases.

In order to solve this technological problem, the present inventors have conducted studies on the injection of positive holes from the support to the undercoat layer.

As a result of the above studies, the present inventors have found that the above technological problem can be solved by an electrophotographic photosensitive member having the following configuration.

Specifically, the present disclosure provides an electrophotographic photosensitive member including a support, an undercoat layer formed directly on the support, and a photosensitive layer formed on the undercoat layer, wherein
when an ionization potential of the undercoat layer is represented by IPu, the IPu is 6.0 eV or higher,
when an ionization potential of the support is represented by IPs, the IPs is lower than the IPu,
the undercoat layer contains a compound (α),
when an ionization potential of the compound (α) is represented by IPα, the IPα is 5.0 eV or higher and 5.4 eV or lower, and
the IPs and the IPα satisfy the following relational expression (1):

$$IPs \geq IP α - 1. . \qquad ( 1 )$$

The present inventors presume a mechanism by which the above technological problems can be solved by the above configuration of the present disclosure, in the following way.

In the undercoat layer that is formed directly on the support, there is contained an electron transporting compound and a large ionization potential, the injection of positive holes from the support to the undercoat layer is small due to the characteristics of the undercoat layer, and electrons in the undercoat layer are removed entirely by transportation of the electrons. Because of this, when electrons are retained in the undercoat layer, the electrons resist being removed from the undercoat layer, and the residual potential tends to easily increase.

In the conventional technology, it is presumed that the residual potential becomes high due to such a reason that the electrons retained in the undercoat layer resist being removed, and that the fluctuation of the light portion potential has become large.

Also, when the ionization potential of the compound contained in the undercoat layer is too small, the residual potential can be reduced, but the balance with the dark portion potential is lost, and the fluctuation in the light portion potential results in increasing.

In the present disclosure, when an ionization potential of the undercoat layer is represented by IPu, the IPu is 6.0 eV or higher, and when an ionization potential of the support is represented by IPs, the IPs is lower than the IPu, when an ionization potential of the compound (α) is represented by IPα, the IPα is 5.0 eV or higher and 5.4 eV or lower, and

the IPs and the IPα satisfies IPs≥IPα−1.0 (1); and it is considered that appropriate injection of positive holes from the support into the undercoat layer is thereby promoted, electrons become easily removed which tend to be retained in the undercoat layer, the residual potential becomes low, and the fluctuation of the light portion potential can be further suppressed.

### <Measurement of Ionization Potential>

The ionization potential is usually derived by photoemission yield spectroscopy in Air (PYSA) or photoelectron yield spectroscopy (PYS). It is known that the numerical values derived by the above two methods differ depending on the difference in the amount of water on the sample surface or the like. The ionization potential in the present disclosure is derived by the photoelectron yield spectroscopy (PYS). The measurement is performed in a nitrogen atmosphere, and the ionization potential can be obtained from an intersection of the slope of a line in the coordinates in which the radiated ultraviolet light is taken on the horizontal axis, and the square root of the photoelectron emission amount is taken on the vertical axis, with the background.

### [Electrophotographic Photosensitive Member]

The electrophotographic photosensitive member according to the present disclosure includes the support, the undercoat layer formed directly on the support, and the photosensitive layer formed on the undercoat layer. The support is preferably cylindrical. The photosensitive layer preferably includes a charge generation layer formed on the undercoat layer, and a positive hole transporting layer formed on the charge generation layer.

A method for manufacturing the electrophotographic photosensitive member of the present disclosure includes a method of preparing a coating liquid for each layer which will be described later, forming a coating film of the coating liquid, and drying and/or curing the coating film. In this case, examples of a method for applying the coating liquid (method for forming a coating film) include blade coating, curtain coating, wire bar coating, and ring coating. Among the methods, dip coating is preferable from the viewpoint of efficiency and productivity.

The support and each layer will be described below.

### <Support>

The support is preferably a cylindrical support. The surface of the support is preferably formed from Al and/or an Al alloy. In addition, the surface of the support may be subjected to hot water treatment, blast treatment, cutting treatment, or the like.

In order to more efficiently obtain the effects of the present disclosure, the ionization potential IPs of the support surface is preferably 5.6 eV or higher and 5.8 eV or lower.

### <Undercoat Layer>

In the undercoat layer of the electrophotographic photosensitive member of the present disclosure, when the ionization potential of the undercoat layer is represented by IPu, the IPu is 6.0 eV or higher,
when an ionization potential of the support is represented by IPs, the IPs is lower than the IPu,
the undercoat layer contains a compound (α),
when an ionization potential of the compound (α) is represented by IPα, the IPα is 5.0 eV or higher and 5.4 eV or lower, and
the IPs and the IPα satisfy the following relational expression (1):

$$IPs \geq IP α - 1. . \qquad ( 1 )$$

In the present disclosure, an ionization potential IPu of the undercoat layer is preferably 6.0 eV or higher and 6.3 eV or lower.

In the present disclosure, from the viewpoint of efficiently injecting positive holes from the support to the undercoat layer, the IPs and the IPα preferably satisfy the following relational expression (2).

$$IPs \geq IP α . \qquad ( 2 )$$

For the same reason, in the present disclosure, the IPs and the IPα more preferably satisfy the following relational expression (3).

$$IPs - IP α \geq 0.3 \qquad ( 3 )$$

In the compound (α) contained in the undercoat layer according to the present disclosure, the IPα is 5.0 eV or higher and 5.4 eV or lower.

The compound (α) contained in the undercoat layer according to the present disclosure is preferably a compound represented by the following formula (α).

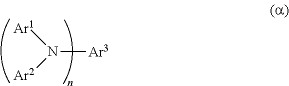

(In the formula (α), Ar¹ and Ar² each independently represent a substituted or unsubstituted phenyl group; the substituent is an alkyl group or an alkoxy group; and Ar³ represents an n-valent aromatic group, and n is an integer of 1 or more and 3 or less.)

The compound (α) represented by the formula (α) may be used alone or in combination of two or more types thereof.

### (Compound (α) Represented by Formula (α))

The compound (α) represented by the formula (α) is a positive hole transporting substance. Specific examples of the compound (α) represented by the formula (α) and the ionization potential IPα of the compound (α) are shown in the following Table 1.

TABLE 1

| Compound | Structure | IPα [eV] |
|---|---|---|
| α1 | 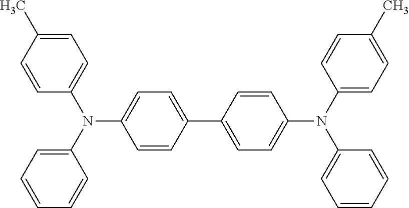 [SMILES: Cc1ccc(N(c2ccccc2)c2ccc(-c3ccc(N(c4ccccc4)c4ccc(C)cc4)cc3)cc2)cc1] | 5.2 |
| α2 | 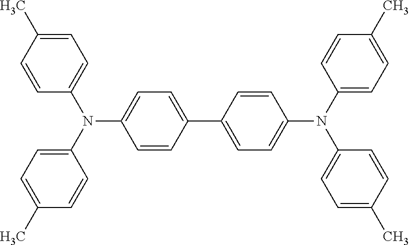 [SMILES: Cc1ccc(N(c2ccc(C)cc2)c2ccc(-c3ccc(N(c4ccc(C)cc4)c4ccc(C)cc4)cc3)cc2)cc1] | 5.3 |
| α3 | 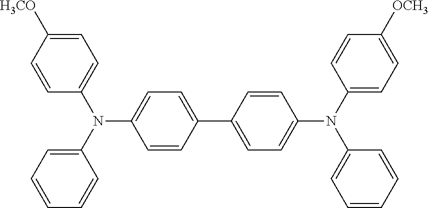 [SMILES: COc1ccc(N(c2ccccc2)c2ccc(-c3ccc(N(c4ccccc4)c4ccc(OC)cc4)cc3)cc2)cc1] | 5.1 |
| α4 | 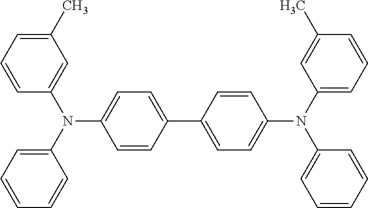 [SMILES: Cc1cccc(N(c2ccccc2)c2ccc(-c3ccc(N(c4ccccc4)c4cccc(C)c4)cc3)cc2)c1] | 5.4 |
| α5 | 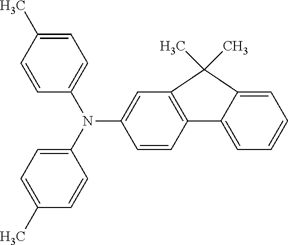 [SMILES: Cc1ccc(N(c2ccc(C)cc2)c2ccc3c(c2)C(C)(C)c2ccccc2-3)cc1] | 5.4 |
| α6 | 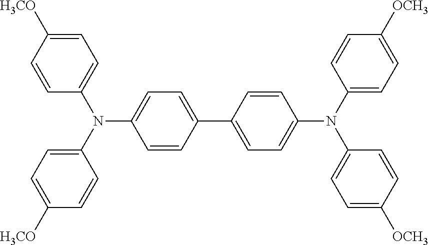 [SMILES: COc1ccc(N(c2ccc(OC)cc2)c2ccc(-c3ccc(N(c4ccc(OC)cc4)c4ccc(OC)cc4)cc3)cc2)cc1] | 5.0 |

The ionization potential in the present disclosure is measured under a nitrogen atmosphere with the use of a photoelectron spectrometer AC-3 manufactured by Riken Keiki Co., Ltd.

The undercoat layer in the present disclosure preferably contains a cured product of a composition containing a compound represented by the following formula (B1) or (B2):

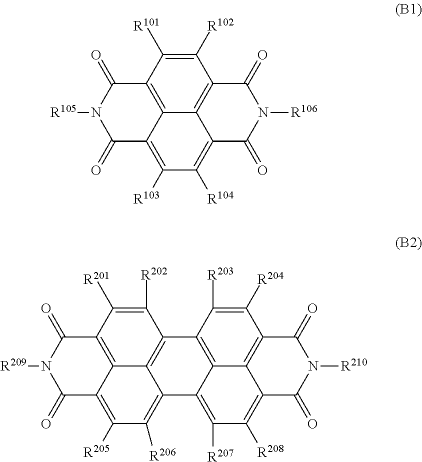

wherein R¹⁰¹ to R¹⁰⁶ and R²⁰¹ to R²¹⁰ each independently represent a monovalent group represented by the following formula (C), a hydrogen atom, a cyano group, a nitro group, a halogen atom, an alkoxycarbonyl group, a substituted or unsubstituted alkyl group, a substituted or unsubstituted aryl group, and a substituted or unsubstituted heterocyclic group, provided that at least one of R¹⁰¹ to R¹⁰⁶ and at least one of R²⁰¹ to R²¹⁰ are monovalent groups represented by the following formula (C); one of the CH₂ of the alkyl group is optionally substituted with O or S, or one of the CH of the alkyl group is optionally substituted with N; a substituent of the substituted alkyl group is at least one group selected from the group consisting of an aryl group, an alkoxycarbonyl group, a halogen atom, and a hydroxy group; and a substituent of the substituted aryl group and the substituted heterocyclic group is at least one group selected from the group consisting of a halogen atom, a nitro group, a cyano group, an alkyl group, a halogen group-substituted alkyl group, and an alkoxy group,

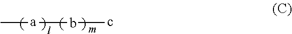

wherein at least one of a, b, and c has at least one group selected from the group consisting of a hydroxy group, a thiol group, an amino group, and a carboxy group; and 1 and m are each independently 0 or 1, and the sum of 1 and m is 0 or more and 2 or less;

a represents an alkylene group having 1 or more and 6 or less carbon atoms in the main chain, an alkylene group having 1 or more and 6 or less carbon atoms in the main chain substituted with an alkyl group having 1 or more and 6 or less carbon atoms, an alkylene group having 1 or more and 6 or less carbon atoms in the main chain substituted with a benzyl group, an alkylene group having 1 or more and 6 or less carbon atoms in the main chain substituted with an alkoxycarbonyl group, or an alkylene group having 1 or more and 6 or less carbon atoms in the main chain substituted with a phenyl group, wherein these alkylene groups optionally have at least one group as a substituent selected from the group consisting of a hydroxy group, a thiol group, an amino group, and a carboxy group; one of the CH₂ in the main chain of each of these alkylene groups is optionally substituted with O or S, or one of the CH in the main chain of each of these alkylene groups is optionally substituted with N;

b represents a phenylene group, a phenylene group substituted with an alkyl group having 1 or more and 6 or less carbon atoms, a phenylene group substituted with a nitro group, a phenylene group substituted with a halogen group, or a phenylene group substituted with an alkoxy group, wherein these phenylene groups optionally have at least one group as a substituent selected from the group consisting of a hydroxy group, a thiol group, an amino group, and a carboxy group; and

c represents a hydrogen atom, a carboxyl group, an alkyl group having 1 or more and 6 or less carbon atoms in the main chain, an alkyl group having 1 or more and 6 or less carbon atoms in the main chain substituted with an alkyl group having 1 or more and 5 or less carbon atoms, wherein these alkyl groups optionally have at least one group as a substituent selected from the group consisting of a hydroxy group, a thiol group, an amino group, and a carboxy group.

In addition, the compound selected from the group consisting of the compounds represented by the formula (B1) and the compounds represented by the formula (B2) may be used alone or in combination of two or more types thereof.

(Compound represented by formula (B1) and compound represented by formula (B2))

The compound represented by the formula (B1) and the compound represented by the formula (B2) are electron transporting substances. The compound represented by the formula (B1) and the compound represented by the formula (B2) are shown in the following Tables 2-1 to 2-7.

Compounds (B101) to (B168) are specific examples of the compound represented by the formula (B1), and compounds (B201) to (B231) are specific examples of the compound represented by the formula (B2). In Tables 2-1 to 2-7, in the case where “(H)” is described for c, the case means that c represents a hydrogen atom in the structure shown in the column of a or b, and that the structure of the formula (B) is the structure shown in the column of a or b. In the case where the column of a or b is (−), the case indicates that 1 or m is 0.

The following are specific examples, and the effect of the present disclosure is not brought about only by the following specific examples. These compounds may be used alone, or a plurality of compounds may be mixed together and used.

TABLE 2-1

| Com- | | | | | | | (C) | | |
|---|---|---|---|---|---|---|---|---|---|
| pound | R¹⁰¹ | R¹⁰² | R¹⁰³ | R¹⁰⁴ | R¹⁰⁵ | R¹⁰⁶ | a | b | c |
| B101 | H | H | H | H | 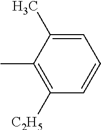 | (C) | 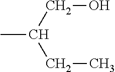 | — | (H) |
| B102 | H | H | H | H | 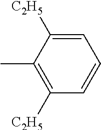 | (C) | 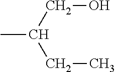 | — | (H) |
| B103 | H | H | H | H | 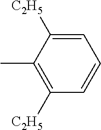 | (C) | — | 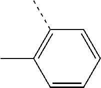 | 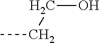 |
| B104 | H | H | H | H | 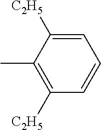 | (C) | — | 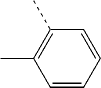 | 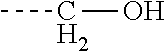 |
| B105 | H | H | H | H | 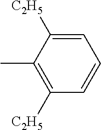 | (C) | — | 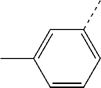 | 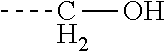 |
| B106 | H | H | H | H | 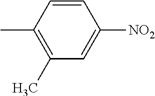 | (C) | 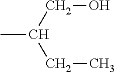 | — | (H) |
| B107 | H | H | H | H | 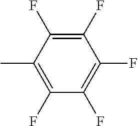 | (C) | 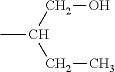 | — | (H) |
| B108 | H | H | H | H | 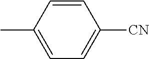 | (C) | 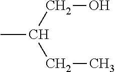 | — | (H) |
| B109 | H | H | H | H | 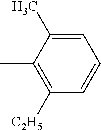 | (C) | 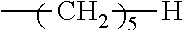 | — | (H) |
| B110 | H | H | H | H | 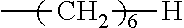 | (C) | 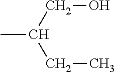 | — | (H) |
| B111 | H | H | H | H | 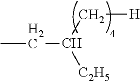 | (C) | — | 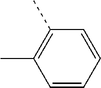 | 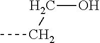 |
| B112 | H | H | H | H | 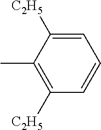 | (C) | — | 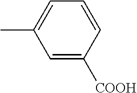 | (H) |
| B113 | H | H | H | H | 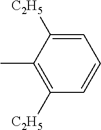 | (C) | — | 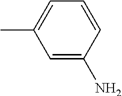 | (H) |
| B114 | H | H | H | H | 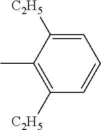 | (C) | — | 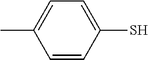 | (H) |
| B115 | H | H | H | H | 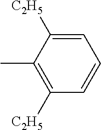 | (C) | 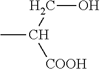 | — | (H) |

TABLE 2-2

| Compound | R¹⁰¹ | R¹⁰² | R¹⁰³ | R¹⁰⁴ | R¹⁰⁵ | R¹⁰⁶ |
|---|---|---|---|---|---|---|
| B116 | H | H | H | H | 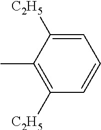 | (C) |
| B117 | H | H | H | H | 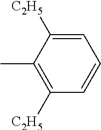 | (C) |
| B118 | 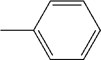 | H | H | 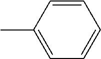 | 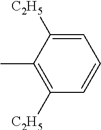 | (C) |
| B119 | CN | H | H | CN | 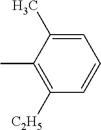 | (C) |
| B120 | (C) | H | H | H | 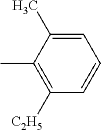 | 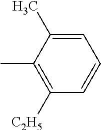 |
| B121 | H | NO₂ | H | NO₂ | 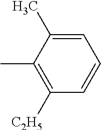 | (C) |
| B122 | H | H | H | H | 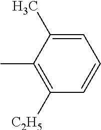 | (C) |
| B123 | H | NO₂ | H | NO₂ | (C) | (C) |
| B124 | H | H | H | H | (C) | (C) |
| B125 | H | H | H | H | (C) | (C) |
| B126 | H | H | H | H | (C) | (C) |
| B127 | H | H | H | H | (C) | (C) |
| B128 | H | H | H | H | (C) | (C) |
| B129 | H | H | H | H | (C) | (C) |
| B130 | H | H | H | H | 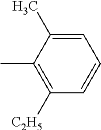 | (C) |
| B132 | H | H | H | H | 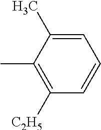 | (C) |

| | (C) | | |
|---|---|---|---|
| Compound | a | b | c |
| B116 | — | 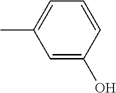 | (H) |
| B117 | — | 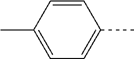 | 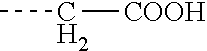 |
| B118 | 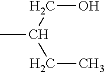 | — | (H) |
| B119 | 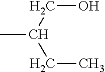 | — | (H) |
| B120 | — | — | —COOH |
| B121 | 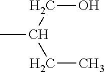 | — | (H) |
| B122 | 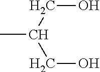 | — | (H) |
| B123 | 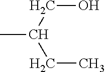 | — | (H) |
| B124 | — | 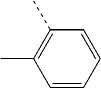 | 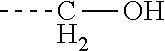 |
| B125 | — | 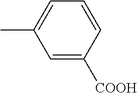 | (H) |
| B126 | — | 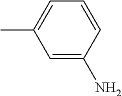 | (H) |
| B127 | — | 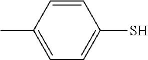 | (H) |
| B128 | 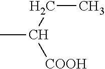 | — | (H) |
| B129 | — | 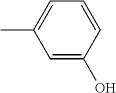 | (H) |
| B130 | 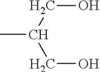 | — | (H) |
| B132 | 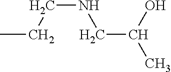 | — | (H) |

TABLE 2-3

| Com- | | | | | | | (C) | | |
|---|---|---|---|---|---|---|---|---|---|
| pound | R¹⁰¹ | R¹⁰² | R¹⁰³ | R¹⁰⁴ | R¹⁰⁵ | R¹⁰⁶ | a | b | c |
| B133 | H | H | H | H | 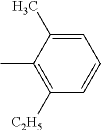 | (C) | 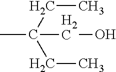 | — | (H) |
| B134 | H | H | H | H | (C) | (C) | 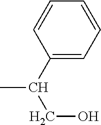 | — | (H) |
| B135 | H | H | H | H | (C) | (C) | 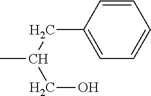 | — | (H) |
| B136 | H | H | H | H | (C) | (C) | 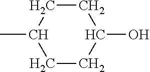 | — | (H) |
| B138 | H | H | H | H | 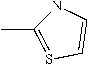 | (C) | 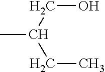 | — | (H) |
| B139 | H | H | H | H | 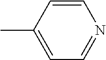 | (C) | 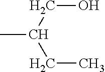 | — | (H) |
| B140 | H | H | H | H | 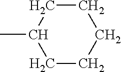 | (C) | 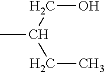 | — | (H) |
| B141 | H | H | H | H | (C) | (C) | 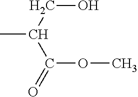 | — | (H) |
| B142 | CN | H | H | CN | 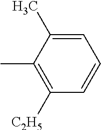 | (C) | 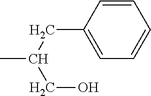 | — | (H) |
| B143 | H | H | H | H | 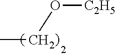 | (C) | 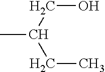 | — | (H) |
| B144 | H | H | H | H | 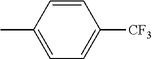 | (C) | 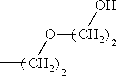 | — | (H) |
| B145 | H | H | H | H | (C) | (C) | 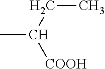 | — | (H) |
| B146 | H | H | H | H | 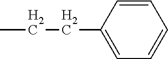 | (C) | 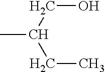 | — | (H) |
| B147 | H | H | H | H | 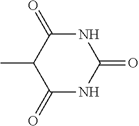 | (C) | 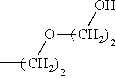 | — | (H) |
| B148 | H | H | H | H | 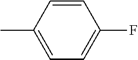 | (C) | 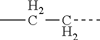 | 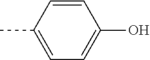 | (H) |
| B149 | H | H | H | H | 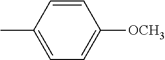 | (C) | — | 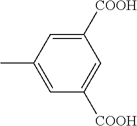 | (H) |

TABLE 2-4

| | | | | | | | (C) | | | (C′) | | |
|---|---|---|---|---|---|---|---|---|---|---|---|---|
| Compound | R¹⁰¹ | R¹⁰² | R¹⁰³ | R¹⁰⁴ | R¹⁰⁵ | R¹⁰⁶ | a | b | c | a | b | c |
| B150 | H | H | H | H | (C) | (C) | 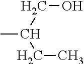 | — | (H) | — | 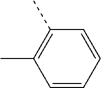 | 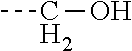 |
| B151 | H | H | H | H | (C) | (C) | — | 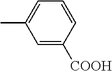 | (H) | 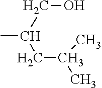 | — | (H) |

TABLE 2-5

| | | | | | | | (C) | | |
|---|---|---|---|---|---|---|---|---|---|
| Compound | R¹⁰¹ | R¹⁰² | R¹⁰³ | R¹⁰⁴ | R¹⁰⁵ | R¹⁰⁶ | a | b | c |
| B152 | H | H | H | H | 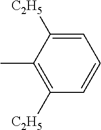 | (C) | 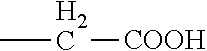 | — | (H) |
| B153 | H | H | H | H | 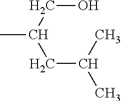 | (C) | — | 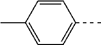 | 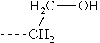 |
| B154 | H | H | H | H | 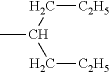 | (C) | 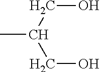 | — | (H) |
| B155 | H | H | H | H | (C) | (C) | 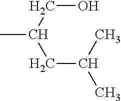 | — | (H) |
| B156 | H | H | H | H | (C) | (C) | 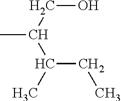 | — | (H) |
| B157 | H | H | H | H | (C) | (C) | 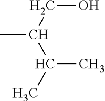 | — | (H) |
| B158 | H | H | H | H | 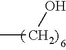 | (C) | 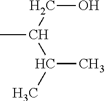 | — | (H) |
| B159 | H | H | H | H | 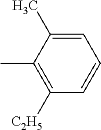 | (C) | 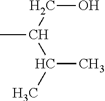 | — | (H) |
| B160 | H | H | H | H | (C) | (C) | 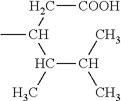 | — | (H) |
| B161 | H | H | H | H | 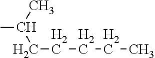 | (C) | 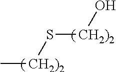 | — | (H) |
| B162 | H | H | H | H | (C) | (C) | 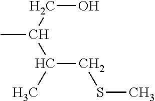 | — | (H) |
| B163 | H | H | H | H | (C) | (C) | 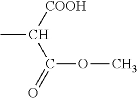 | — | (H) |
| B164 | H | H | H | H | 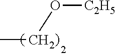 | (C) | 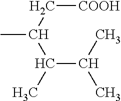 | — | (H) |
| B165 | H | H | H | H | 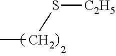 | (C) | 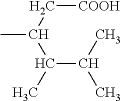 | — | (H) |
| B166 | H | H | H | H | 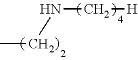 | (C) | 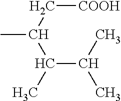 | — | (H) |
| B167 | H | H | H | H | 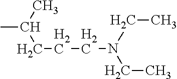 | (C) | 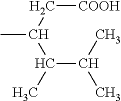 | — | (H) |
| B168 | H | H | H | H | 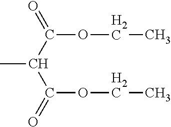 | (C) | 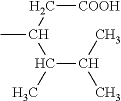 | — | (H) |

TABLE 2-6

| | | | | | | | | | | | (C) |
|---|---|---|---|---|---|---|---|---|---|---|---|
| Compound | R²⁰¹ | R²⁰² | R²⁰³ | R²⁰⁴ | R²⁰⁵ | R²⁰⁶ | R²⁰⁷ | R²⁰⁸ | R²⁰⁹ | R²¹⁰ | a |
| B201 | H | H | H | H | H | H | H | H | 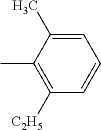 | (C) | 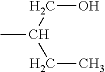 |
| B202 | H | H | H | H | H | H | H | H | 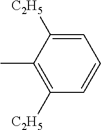 | (C) | 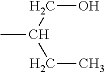 |
| B203 | H | H | H | H | H | H | H | H | 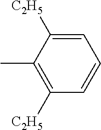 | (C) | — |
| B204 | H | H | H | H | H | H | H | H | 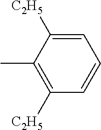 | (C) | — |
| B205 | H | H | H | H | H | H | H | H | 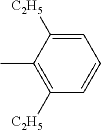 | (C) | — |
| B206 | H | H | H | H | H | H | H | H | 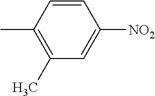 | (C) | 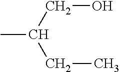 |
| B207 | H | H | H | H | H | H | H | H | 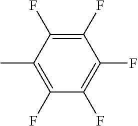 | (C) | 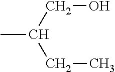 |
| B208 | H | H | H | H | H | H | H | H | 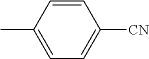 | (C) | 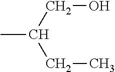 |
| B209 | H | H | H | H | H | H | H | H | 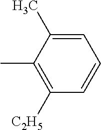 | (C) | 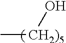 |
| B210 | H | H | H | H | H | H | H | H | 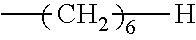 | (C) | 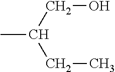 |
| B211 | H | H | H | H | H | H | H | H | 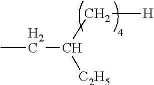 | (C) | — |
| B212 | H | H | H | H | H | H | H | H | 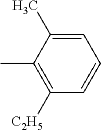 | (C) | — |
| B213 | H | H | H | H | H | H | H | H | 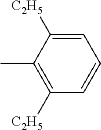 | (C) | — |
| B214 | H | H | H | H | H | H | H | H | 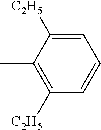 | (C) | — |
| B215 | H | H | H | H | H | H | H | H | 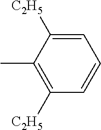 | (C) | 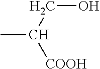 |

| | (C) | |
|---|---|---|
| Compound | b | c |
| B201 | — | (H) |
| B202 | — | (H) |
| B203 | 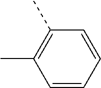 | 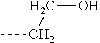 |
| B204 | 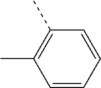 | 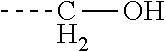 |
| B205 | 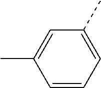 | 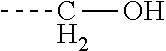 |
| B206 | — | (H) |
| B207 | — | (H) |
| B208 | — | (H) |
| B209 | — | (H) |
| B210 | — | (H) |
| B211 | 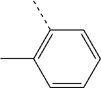 | 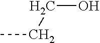 |
| B212 | 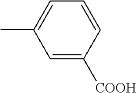 | (H) |
| B213 | 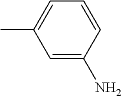 | (H) |
| B214 | 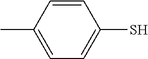 | (H) |
| B215 | — | (H) |

TABLE 2-7

| Compound | R²⁰¹ | R²⁰² | R²⁰³ | R²⁰⁴ | R²⁰⁵ | R²⁰⁶ | R²⁰⁷ | R²⁰⁸ | R²⁰⁹ | R²¹⁰ |
|---|---|---|---|---|---|---|---|---|---|---|
| B216 | H | H | H | H | H | H | H | H | 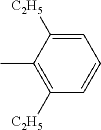 | (C) |
| B217 | H | H | H | H | H | H | H | H | 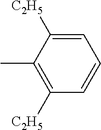 | (C) |
| B218 | H | H | H | H | H | H | H | H | 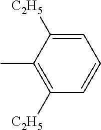 | (C) |
| B219 | H | CN | H | H | H | H | CN | H | 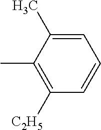 | (C) |
| B220 | H | 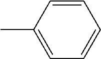 | H | H | H | H | 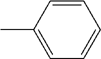 | H | 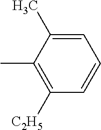 | (C) |
| B221 | H | (C) | H | H | H | H | H | H | 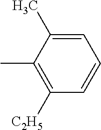 | 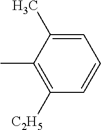 |
| B222 | H | Cl | Cl | H | H | Cl | Cl | H | 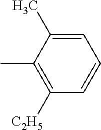 | (C) |
| B223 | H | H | H | H | H | H | H | H | 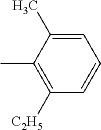 | (C) |
| B224 | H | H | H | H | H | H | H | H | (C) | (C) |
| B225 | H | H | H | H | H | H | H | H | (C) | (C) |
| B226 | H | H | H | H | H | H | H | H | (C) | (C) |
| B227 | H | H | H | H | H | H | H | H | (C) | (C) |
| B228 | H | H | H | H | H | H | H | H | (C) | (C) |
| B229 | H | H | H | H | H | H | H | H | (C) | (C) |
| B230 | H | H | H | H | H | H | H | H | (C) | (C) |
| B231 | H | H | H | H | H | H | H | H | 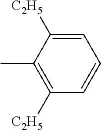 | (C) |

| | (C) | | |
|---|---|---|---|
| Compound | a | b | c |
| B216 | 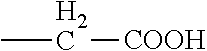 | — | (H) |
| B217 | — | 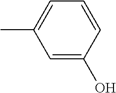 | (H) |
| B218 | — | 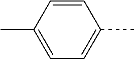 | 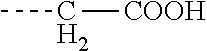 |
| B219 | 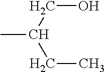 | — | (H) |
| B220 | 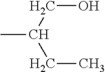 | — | (H) |
| B221 | — | — | —COOH |
| B222 | 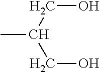 | — | (H) |
| B223 | 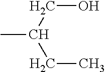 | — | (H) |
| B224 | 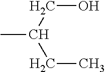 | — | (H) |
| B225 | — | 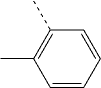 | 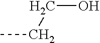 |
| B226 | — | 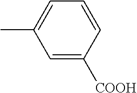 | (H) |
| B227 | — | 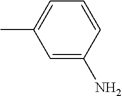 | (H) |
| B228 | — | 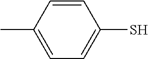 | (H) |
| B229 | 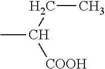 | — | (H) |
| B230 | — | 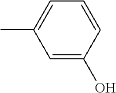 | (H) |
| B231 | — | 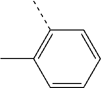 | 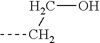 |

The structure of the monovalent group represented by the formula (C) listed in the above table can be described as follows.

Specifically, the monovalent group represented by the formula (C) is an alkyl group having 1 or more and 12 or less carbon atoms, a phenyl group, or a phenylalkyl group having 6 or more and 12 or less carbon atoms, each of which optionally have a substituent,

wherein a substituent which the alkyl group having 1 or more and 12 or less carbon atoms optionally have is any one of a hydroxy group, a thiol group, an amino group, a carboxy group, an alkoxycarbonyl group, and an alkoxy group;

the substituent which the phenyl group or the phenylalkyl group having 6 or more and 12 or less carbon atoms optionally have is a methyl group, an ethyl group, a hydroxymethyl group, a hydroxyethyl group, a carboxymethyl group, a carboxyethyl group, a hydroxy group, a thiol group, an amino group, a carboxy group, or an alkoxycarbonyl group; and

one CH₂ of the alkyl group having 1 or more and 12 or less carbon atoms, or the alkyl group of the phenylalkyl group having 6 or more and 12 or less carbon atoms is optionally substituted with O or S, or one CH of the alkyl group is optionally substituted with N,

wherein the monovalent group represented by the formula (C) includes any one of a hydroxy group, a thiol group, an amino group, and a carboxy group.

In order to more efficiently obtain the effects of the present disclosure, a value of a mass ratio of a content of the compound (α) in the above composition to a content of the compound represented by the formula (B1) or (B2) in the above composition is preferably 0.035 or more and 0.150 or less. In other words, the content of the compound (α) is preferably 3.5% by mass or more and 15% by mass or less with respect to the compound represented by the formula (B1) or (B2).

The undercoat layer may contain a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide-imide resin, a cellulose resin, and the like, as a resin.

The undercoat layer may contain a metal oxide particle, a metal particle, an electroconductive polymer and the like, for the purpose of enhancing electrical characteristics.

Examples of the metal oxide include indium tin oxide, tin oxide, indium oxide, titanium oxide, zinc oxide, aluminum oxide and silicon dioxide. Examples of the metal include gold, silver and aluminum.

In addition, the undercoat layer may further contain an additive.

In order to more efficiently obtain the effects of the present disclosure, the film thickness of the undercoat layer is preferably 0.5 μm or larger and 2.4 μm or smaller.

The undercoat layer can be formed by preparing a coating liquid for the undercoat layer, which contains the above described material and a solvent, forming a coating film of the coating liquid for the undercoat layer, and drying and/or curing the coating film. Examples of the solvent which is used in the coating liquid for the undercoat layer include an alcohol-based solvent, a ketone-based solvent, an ether-based solvent, an ester-based solvent, and an aromatic hydrocarbon-based solvent.

### <Photosensitive Layer>

The photosensitive layer of the electrophotographic photosensitive member is mainly classified into (1) a laminated type photosensitive layer and (2) a single-layer type photosensitive layer. (1) The laminated type photosensitive layer includes a charge generation layer containing a charge generating substance and a charge transport layer (positive hole transporting layer) containing a charge transporting substance. (2) The single-layer type photosensitive layer is a photosensitive layer which contains both the charge generating substance and a charge transporting substance.

### (1) Laminated Type Photosensitive Layer

The laminated type photosensitive layer includes the charge generation layer and the charge transport layer.

### (1-1) Charge Generation Layer

The charge generation layer preferably contains the charge generating substance and a resin (binder resin).

Examples of the charge generating substance include an azo pigment, a perylene pigment, a polycyclic quinone pigment, an indigo pigment, and a phthalocyanine pigment. Among these pigments, the azo pigment and the phthalocyanine pigment are preferable. Among the phthalocyanine pigments, an oxytitanium phthalocyanine pigment, a chlorogallium phthalocyanine pigment and a hydroxygallium phthalocyanine pigment are preferable.

A content of the charge generating substance in the charge generation layer is preferably 40% by mass or more and 85% by mass or less, is more preferably 60% by mass or more and 80% by mass or less with respect to the total mass of the charge generation layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin and a polyvinyl chloride resin. Among these resins, the polyvinyl butyral resin is preferable.

In addition, the charge generation layer may contain an additive such as an anti-oxidizing agent and an ultraviolet absorbing agent. Specific examples thereof include a hindered phenol compound, a hindered amine compound, a sulfur compound, a phosphorus compound, and a benzophenone compound.

A film thickness of the charge generation layer is preferably 0.1 μm or larger and 1 μm or smaller, and is more preferably 0.15 μm or larger and 0.4 μm or smaller.

The charge generation layer can be formed by preparing a coating liquid for the charge generation layer containing the above described material and a solvent, forming a coating film of the coating liquid for the charge generation layer, and drying the coating film. Examples of the solvent to be used for the coating liquid for the charge generation layer include an alcohol-based solvent, a sulfoxide-based solvent, a ketone-based solvent, an ether-based solvent, an ester-based solvent and an aromatic hydrocarbon-based solvent.

### (1-2) Charge Transport Layer

The charge transport layer preferably contains the charge transporting substance and a resin (binder resin).

Examples of the charge transporting substance include a polycyclic aromatic compound, a heterocyclic compound, a hydrazone compound, a styryl compound, an enamine compound, a benzidine compound, a triarylamine compound, and a resin having a group which is derived from these substances. Among these compounds, the triarylamine compound and the benzidine compound are preferable.

It is preferable for a content of the charge transporting substance in the charge transport layer to be 25% by mass or more and 70% by mass or less, and is more preferable to be 30% by mass or more and 55% by mass or less, with respect to the total mass of the charge transport layer.

Examples of the resin include a polyester resin, a polycarbonate resin, an acrylic resin and a polystyrene resin. Among these resins, the polycarbonate resin and the polyester resin are preferable. In the polyester resins, a polyarylate resin is particularly preferable.

A content ratio (mass ratio, charge transporting substance: resin) of the charge transporting substance to the resin in the charge transport layer is preferably 4:10 to 20:10, and is more preferably 5:10 to 12:10.

The charge transport layer may contain an additive such as an anti-oxidizing agent, an ultraviolet absorbing agent, a plasticizing agent, a leveling agent, a slipperiness imparting agent and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

It is preferable for a film thickness of the charge transport layer to be 5 μm or larger and 50 μm or smaller, is more preferable to be 8 μm or larger and 40 μm or smaller, and is particularly preferable to be 10 μm or larger and 30 μm or smaller.

The charge transport layer can be formed by preparing a coating liquid for the charge transport layer containing the above described material and a solvent, forming a coating film of the coating liquid for the charge transport layer, and drying the coating film. Examples of the solvent to be used for the coating liquid for the charge transport layer include an alcohol-based solvent, a ketone-based solvent, an ether-based solvent, an ester-based solvent and an aromatic hydrocarbon-based solvent. Among these solvents, the ether-based solvent and the aromatic hydrocarbon-based solvent are preferable.

### <Protective Layer>

In the present disclosure, a protective layer may be provided on the photosensitive layer. By having the protective layer provided therein, the electrophotographic photosensitive member can enhance its durability.

The protective layer preferably contains an electroconductive particle and/or a charge transporting substance, and a resin.

Examples of the electroconductive particle include a metal oxide particle and a metal particle. Examples of the metal oxide include titanium oxide, zinc oxide, tin oxide and indium oxide.

Examples of the charge transporting substance include a polycyclic aromatic compound, a heterocyclic compound, a hydrazone compound, a styryl compound, an enamine compound, a benzidine compound, a triarylamine compound, and a resin having a group derived from these substances. Among these substances, the triarylamine compound and the benzidine compound are preferable.

Examples of the resin include a polyester resin, an acrylic resin, a phenoxy resin, a polycarbonate resin, a polystyrene resin, a phenol resin, a melamine resin and an epoxy resin. Among these resins, the polycarbonate resin, the polyester resin and the acrylic resin are preferable.

The protective layer may also be formed as a cured film by polymerization of a composition which contains a monomer having a polymerizable functional group. Examples of the polymerization reaction at this time include a thermal polymerization reaction, a photopolymerization reaction, and a radiation-induced polymerization reaction. Examples of the polymerizable functional group, which the monomer having a polymerizable functional group has, include an acryloyl group and a methacryloyl group. A compound having charge transport ability may be used as the monomer having the polymerizable functional group.

The protective layer may contain an additive such as an anti-oxidizing agent, an ultraviolet absorbing agent, a plasticizing agent, a leveling agent, a slipperiness imparting agent, and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

The film thickness of the protective layer is preferably 0.5 μm or larger and 10 μm or smaller, and is more preferably 1 μm or larger and 7 μm or smaller.

The protective layer can be formed by preparing a coating liquid for the protective layer, which contains the above described material and a solvent, forming a coating film of the coating liquid for the protective layer, and drying and/or curing the coating film. Examples of the solvent to be used in the coating liquid for the protective layer include an alcohol-based solvent, a ketone-based solvent, an ether-based solvent, a sulfoxide-based solvent, an ester-based solvent, and an aromatic hydrocarbon-based solvent.

### [Process Cartridge and Electrophotographic Apparatus]

A process cartridge of the present disclosure integrally supports: the above described electrophotographic photosensitive member; and at least one unit selected from the group consisting of a charging unit, a developing unit and a cleaning unit, the process cartridge being detachably attachable to a main body of an electrophotographic apparatus.

The electrophotographic apparatus of the present disclosure includes: the above described electrophotographic photosensitive member; and a charging unit, an exposure unit, a developing unit, and a transfer unit.

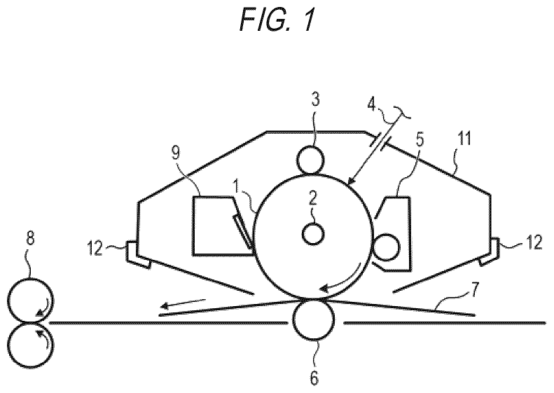

FIG. 1 shows one example of an outline configuration of an electrophotographic apparatus including the process cartridge provided with the electrophotographic photosensitive member.

A cylindrical electrophotographic photosensitive member 1 is rotationally driven around a shaft 2 in a direction of the arrow at a predetermined peripheral velocity. The surface of the electrophotographic photosensitive member 1 is electrostatically charged to a predetermined positive or negative potential by a charging unit 3.

In FIG. 1, a roller charging system by a roller type charging member (charging roller) is shown, but a charging system such as a corona charging system, a proximity charging system or an injection charging system may also be adopted.

The surface of the electrostatically charged electrophotographic photosensitive member 1 is irradiated with exposure light 4 emitted from an exposure unit (not illustrated), and an electrostatic latent image corresponding to objective image information is formed on the surface. The electrostatic latent image formed on the surface of the electrophotographic photosensitive member 1 is developed by a toner accommodated in a developing unit 5, and a toner image is formed on the surface of the electrophotographic photosensitive member 1. The toner image formed on the surface of the electrophotographic photosensitive member 1 is transferred onto a transfer material 7 by a transfer unit 6. The transfer material 7 to which the toner image has been transferred is conveyed to a fixing unit 8, is subjected to fixing treatment of the toner image, and is printed out to the outside of the electrophotographic apparatus.

The electrophotographic apparatus may include a cleaning unit 9 for removing an attached substance such as a toner remaining on the surface of the electrophotographic photosensitive member 1 after transfer. Alternatively, the cleaning unit 9 may not be separately provided, but a so-called cleanerless system may be used that removes the above attached substance by the developing unit 5 or the like.

The electrophotographic apparatus may have a diselectrifying mechanism that subjects the surface of the electrophotographic photosensitive member 1 to a diselectrifying process by pre-exposure light 10 emitted from a pre-exposure unit (not illustrated). In addition, a guiding unit 12 such as a rail may also be provided in order to detachably attach the process cartridge 11 of the present disclosure to the main body of the electrophotographic apparatus.

The electrophotographic photosensitive member of the present disclosure can be used in a laser beam printer, an LED printer, a copying machine, a facsimile, a combined machine thereof and the like.

### EXAMPLES

The present disclosure will be described below in more detail with reference to Examples and Comparative Examples. The present disclosure is not limited to the following Examples at all, as long as the present disclosure does not exceed the gist thereof. Herein, “part(s)” in the description of the following Examples is based on mass unless otherwise specified.

[Production example of compound represented by formula (B1) and compound represented by formula (B2)]

The compound represented by the formula (B1) (derivative of electron transporting substance) can be synthesized with the use of a known synthesis method described in, for example, U.S. Pat. Nos. 4,442,193, 4,992,349, 5,468,583, and Chemistry of materials, Vol. 19, No. 11, 2703 to 2705 (2007). Alternatively, the compound can be synthesized by a reaction between naphthalenetetracarboxylic dianhydride and a monoamine derivative, which are commercially available from Tokyo Chemical Industry Co., Ltd., Sigma-Aldrich Japan K. K., and Johnson Matthey Japan G. K.

The compound represented by the formula (B1) includes a polymerizable functional group (hydroxy group, thiol group, amino group, and carboxy group) which can be polymerized with an isocyanate group of an isocyanate compound. As a method for introducing these substituents into the compound represented by the formula (B1), there are a method of directly introducing a polymerizable functional group into the compound represented by the formula (B1), and a method for introducing a structure having the above polymerizable functional group or a functional group which can be a precursor of the polymerizable functional group. Examples of the latter method include a method of introducing an aryl group containing a functional group, with the use of a cross-coupling reaction which is based on a halide of a naphthyl imide derivative and uses a palladium catalyst and a base. Examples of the method also include a method of introducing an alkyl group containing a functional group with the use of a cross-coupling reaction which is based on a halide of a naphthyl imide derivative and uses a FeCl₃ catalyst and a base. In addition, examples of the method also include a method of introducing a hydroxyalkyl group or a carboxyl group, by subjecting a halide of a naphthyl imide derivative to lithiation, and then allowing an epoxy compound or CO₂ to act on the lithiated product. There is a method of using a naphthalenetetracarboxylic dianhydride derivative or a monoamine derivative each of which has the above polymerizable functional group or a functional group that can be a precursor of the polymerizable functional group, as a raw material for synthesizing the naphthyl imide derivative.

A compound represented by the formula (B2) (derivative of electron transporting substance) can be synthesized with the use of a known synthesis method which is described, for example, in Journal of the American Chemical Society, Vol. 129, No. 49, 15259 to 15278 (2007). Alternatively, the compound can be synthesized by a reaction between perylenetetracarboxylic dianhydride and a monoamine derivative, which are commercially available from Tokyo Chemical Industry Co., Ltd., Sigma-Aldrich Japan K. K., and Johnson Matthey Japan G. K, as reagents.

The compound represented by the formula (B2) has a functional group (hydroxy group, thiol group, amino group, and carboxy group) which can be polymerized with the isocyanate group of the isocyanate compound. As a method for introducing these polymerizable functional groups into the compound represented by the formula (B2), there is a method of introducing a structure having the above polymerizable functional group or a functional group which can be a precursor of the polymerizable functional group, in addition to a method of directly introducing the polymerizable functional group into the compound represented by the formula (B2). Examples of the latter method include a method of using the cross-coupling reaction which is based on a halide of a peryleneimide derivative and uses a palladium catalyst and a base. In addition, for example, there is a method of using the cross-coupling reaction which is based on a halide of a peryleneimide derivative and uses a FeCl₃ catalyst and a base. In addition, there is a method of using a perylenetetracarboxylic dianhydride derivative or a monoamine derivative each of which has the polymerizable functional group or a functional group that can be a precursor of the polymerizable functional group, as a raw material at the time when the peryleneimide derivative is synthesized.

### Synthesis Example 1

Under a nitrogen atmosphere, 5.4 parts of naphthalenetetracarboxylic dianhydride, 4 parts of 2-methyl-6-ethylaniline, and 3 parts of 2-amino-1-butanol were added to 200 parts of dimethylacetamide, the mixture was stirred at room temperature for 1 hour, and a solution was prepared. After the solution was prepared, the solution was refluxed for 8 hours; the precipitate was separated by filtration, and recrystallized in ethyl acetate; and 1.0 part of a compound B101 was obtained.

### Synthesis Example 2

Under a nitrogen atmosphere, 5.4 parts of naphthalenetetracarboxylic dianhydride, 4 parts of 4-heptylamine, and 3 parts of 2-amino-1,3-propanediol were added to 200 parts of dimethyl acetamide, the mixture was stirred at room temperature for 1 hour, and a solution was prepared. After the solution was prepared, the solution was refluxed for 8 hours, and a target substance was separated by silica gel column chromatography (developing solvent: ethyl acetate/toluene), and then a fraction containing the target substance was concentrated. The concentrated product was recrystallized in a mixed solution of ethyl acetate/toluene, and 2.0 parts of a compound B154 was obtained.

### Synthesis Example 3

Under a nitrogen atmosphere, 7.4 parts of perylenetetracarboxylic dianhydride (produced by Tokyo Chemical Industry Co., Ltd.), 4 parts of 2,6-diethylaniline (produced by Tokyo Chemical Industry Co., Ltd.), and 4 parts of 2-aminophenyl ethanol were added to 200 parts of dimethyl acetamide, the mixture was stirred at room temperature for 1 hour, and a solution was prepared. After the solution was prepared, the solution was refluxed for 8 hours; the precipitate was separated by filtration, and recrystallized in ethyl acetate; and 5.0 parts of a compound B203 was obtained.

### <Manufacturing of Support>

### (Manufacturing Example of Support 1)

A support 1 was obtained by obtaining an aluminum cylinder (JIS-A3003, aluminum alloy) which had a length of 370 mm and a diameter of 30.5 mm, and was surface-roughened by being subjected to machining at a 0.4 mm pitch with the use of a bite of R 40 mm, then by subjecting the aluminum cylinder to ultrasonic cleaning in an alkaline liquid having a pH level of 11, removing the alkaline liquid with pure water, leaving the aluminum cylinder at rest in hot water at 95° C. for 90 seconds, and then drying the aluminum cylinder at room temperature.

### (Manufacturing Example of Support 2)

A support 2 was obtained by obtaining an aluminum cylinder (JIS-A3003, aluminum alloy) which had a length of 370 mm and a diameter of 30.5 mm, and was surface-roughened by being subjected to machining at a 0.4 mm pitch with the use of a bite of R 40 mm, then by subjecting the aluminum cylinder to ultrasonic cleaning in an alkaline liquid having a pH level of 11, removing the alkaline liquid with pure water, leaving the aluminum cylinder at rest in hot water at 95° C. for 60 seconds, and then drying the aluminum cylinder at room temperature.

### (Manufacturing Example of Support 3)

A support 3 was obtained by obtaining an aluminum cylinder (JIS-A3003, aluminum alloy) which had a length of 370 mm and a diameter of 30.5 mm, and was surface-roughened by being subjected to machining at a 0.4 mm pitch with the use of a bite of R 40 mm, then by subjecting the aluminum cylinder to ultrasonic cleaning in an alkaline liquid having a pH level of 11, removing the alkaline liquid with pure water, leaving the aluminum cylinder at rest in hot water at 95° C. for 100 seconds, and then drying the aluminum cylinder at room temperature.

### (Manufacturing Example of Support 4)

A support 4 was obtained by obtaining an aluminum cylinder (JIS-A3003, aluminum alloy) which had a length of 370 mm and a diameter of 30.5 mm, and was surface-roughened by being subjected to machining at a 0.4 mm pitch with the use of a bite of R 40 mm, then by subjecting the aluminum cylinder to ultrasonic cleaning in an alkaline liquid having a pH level of 11, removing the alkaline liquid with pure water, leaving the aluminum cylinder at rest in warm water at 60° C. for 15 seconds, and then drying the aluminum cylinder at room temperature.

### <Manufacturing of Electrophotographic Photosensitive Member>

### (Manufacturing Example of Photosensitive Member 1)

Support 1 was used as a support.

Next, 3.11 parts of the compound (B154) as an electron transporting substance, 0.40 parts of a styrene-acrylic resin (trade name: UC-3920, produced by Toagosei Co., Ltd.) and 0.4 parts of a polyvinyl butyral resin (trade name: BX-1, produced by Sekisui Chemical Co., Ltd.) as resins, and 6.49 parts of a blocked isocyanate compound (trade name: SBB-70P, produced by Asahi Kasei Corp.) as an isocyanate compound were dissolved in a mixed solvent of 48 parts of 1-butanol and 24 parts of acetone. To this solution, such a liquid was added that 0.25 parts of a compound (α1) (produced by Tokyo Chemical Industry Co., Ltd.) was dissolved in 6 parts of tetrahydrofuran, and the mixture was stirred for 1 hour. After that, the mixture was subjected to a pressure filtration which uses a Teflon (trademark) filter (product name: PF020) manufactured by ADVANTEC. The obtained coating liquid for the undercoat layer was applied onto the above support by dip coating, and the obtained coating film was heated at 170° C. for 40 minutes to be cured (polymerized), and thereby the undercoat layer was formed on the support, which had a film thickness of 1.8 μm.

Next, 20 parts of a crystal form of hydroxygallium phthalocyanine (charge generating substance) which had peaks at 7.4° and 28.2° of Bragg angles 2θ±0.2° in CuKα characteristic X-ray diffraction, 0.2 parts of a calixarene compound represented by the following formula (P):

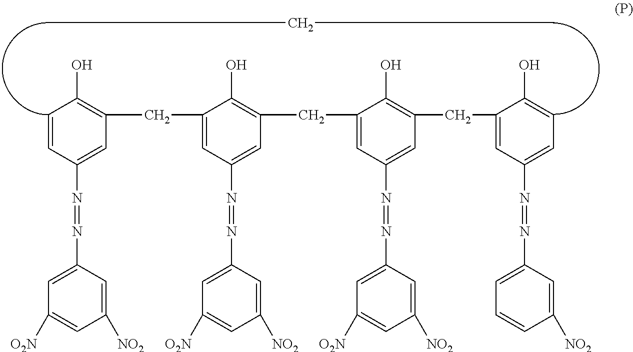

10 parts of polyvinyl butyral (trade name: S-LEC BX-1, produced by Sekisui Chemical Co., Ltd.) and 600 parts of cyclohexane were charged into a sand mill which uses glass beads having diameters of 1 mm, and the mixture was subjected to dispersion treatment for 4 hours. After that, 700 parts of ethyl acetate was added to the mixture, and thereby, a coating liquid for a charge generation layer was prepared. This coating liquid for the charge generation layer was applied onto the above undercoat layer by dip coating, and the obtained coating film was dried at 80° C. for 15 minutes, and thereby, a charge generation layer was formed which had a film thickness of 0.17 μm.

Next, a coating liquid for the charge transport layer was prepared by dissolving 30 parts of a compound represented by the following formula (Q) (charge transporting substance), 60 parts of a compound represented by the following formula (R) (charge transporting substance), and 10 parts of a compound represented by the following formula(S) (charge transporting substance), and

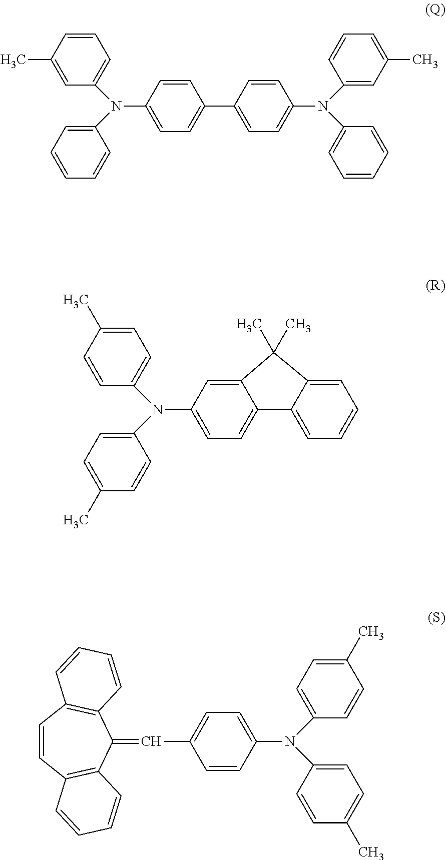

100 parts of a polycarbonate resin (trade name: Iupilon Z400, produced by Mitsubishi Engineering-Plastics Corporation, bisphenol Z type polycarbonate), and 0.02 parts of a polycarbonate resin represented by the following formula (T) (viscosity-average molecular weight Mv: 20000)

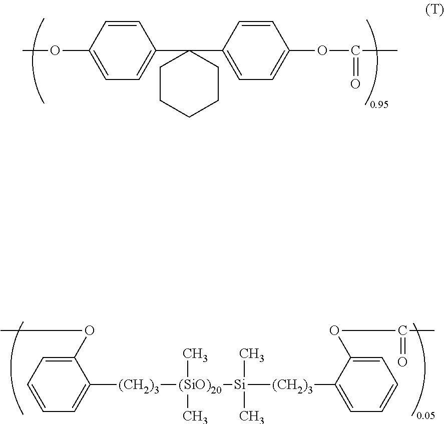

wherein 0.95 and 0.05 is a molar ratio (copolymerization ratio) between the two units,

in a mixed solvent of 600 parts of mixed xylene and 200 parts of dimethoxymethane. The coating liquid for the charge transport layer was applied onto the above charge generation layer by dip coating to form a coating film, and the obtained coating film was dried at 100° C. for 30 minutes to form the charge transport layer having a film thickness of 18 μm.

Next, a mixed solvent of 20 parts of 1,1,2,2,3,3,4-heptafluorocyclopentane (trade name: ZEORORA H, produced by Zeon Corporation) and 20 parts of 1-propanol was prepared, and was filtered through a polyflon filter (trade name: PF-040, manufactured by Advantec Toyo Kaisha, Ltd.).

A positive hole transporting compound represented by the following formula (U) in an amount of 90 parts,

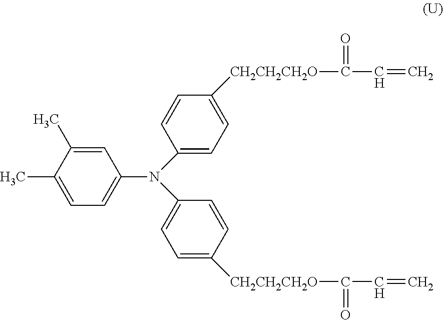

70 parts of 1,1,2,2,3,3,4-heptafluorocyclopentane and 70 parts of 1-propanol were added to the above mixed solvent. The resultant was filtered through a polyflon filter (trade name: PF-020, manufactured by Advantec Toyo Kaisha, Ltd.), and thereby, a coating liquid for a second charge transport layer (protective layer) was prepared. The coating liquid for the second charge transport layer was applied onto the above charge transport layer by dip coating, and the obtained coating film was dried in the air at 50° C. for 6 minutes. After that, the coating film was irradiated with an electronic beam for 1.6 seconds under conditions of an accelerating voltage of 70 kV and an absorbed dose of 8000 Gy, while the support (body to be irradiated) was rotated at 200 rpm. Subsequently, the temperature was raised from 25° C. to 125° C. over 30 seconds in nitrogen, and the coating film was heated. When the coating film was irradiated with the electron beam and was subsequently heated, a concentration of oxygen in the atmosphere was 15 ppm. Next, the resultant was subjected to heat treatment at 100° C. for 30 minutes in the air, and thereby, the second charge transport layer (protective layer) was formed which was cured by the electron beam and had a film thickness of 5 μm.

Next, linear grooves were formed on the surface of the protective layer with the use of a polishing sheet (trade name: GC3000, manufactured by Riken Corundum Co., Ltd.). A feed speed of the polishing sheet was set at 40 mm/min, the number of rotations of the workpiece was set at 240 rpm, and a pressing pressure of the polishing sheet against the workpiece was set at 7.5 N/m². A feed direction of the polishing sheet and a rotation direction of the workpiece were set to be the same. In addition, a backup roller was used which had an outer diameter of 40 cm, and an Asker C hardness of 40. Under these conditions, linear grooves were formed on the peripheral surface of the workpiece, over 10 seconds.

Thus, a photosensitive member 1 was manufactured.

### (Manufacturing Examples of Electrophotographic Photosensitive Members 2 to 76)

Electrophotographic photosensitive members were manufactured in the same way as in the manufacturing example of the photosensitive member 1, except that the support, the compound represented by the formula (α), the addition amount, and the film thickness of the undercoat layer shown in Table 3-1-1 and Table 3-1-2 were changed as shown in Table 3-1-1 and Table 3-1-2. The obtained electrophotographic photosensitive members shall be designated as photosensitive members 2 to 76.

TABLE 3-1-1

| | | | Compound (α) | | | Compound (B1) (B2) | |
|---|---|---|---|---|---|---|---|
| | | | | | Addition | | Addition |
| | Photosensitive | | | IPα | amount | Compound | amount |
| Example | member | Support | Compound | [eV] | [parts] | (B1) (B2) | [parts] |
| Example 1 | Photosensitive | Support 1 | α1 | 5.2 | 0.25 | B154 | 3.11 |
| | member 1 | | | | | | |
| Example 2 | Photosensitive | Support 1 | α2 | 5.3 | 0.25 | B154 | 3.11 |
| | member 2 | | | | | | |
| Example 3 | Photosensitive | Support 1 | α3 | 5.1 | 0.25 | B154 | 3.11 |
| | member 3 | | | | | | |
| Example 4 | Photosensitive | Support 1 | α4 | 5.4 | 0.25 | B154 | 3.11 |
| | member 4 | | | | | | |
| Example 5 | Photosensitive | Support 1 | α5 | 5.4 | 0.25 | B154 | 3.11 |
| | member 5 | | | | | | |
| Example 6 | Photosensitive | Support 1 | α6 | 5.0 | 0.25 | B154 | 3.11 |
| | member 6 | | | | | | |
| Example 7 | Photosensitive | Support 2 | α1 | 5.2 | 0.25 | B154 | 3.11 |
| | member 7 | | | | | | |
| Example 8 | Photosensitive | Support 2 | α2 | 5.3 | 0.25 | B154 | 3.11 |
| | member 8 | | | | | | |
| Example 9 | Photosensitive | Support 2 | α3 | 5.1 | 0.25 | B154 | 3.11 |
| | member 9 | | | | | | |
| Example 10 | Photosensitive | Support 2 | α4 | 5.4 | 0.25 | B154 | 3.11 |
| | member 10 | | | | | | |
| Example 11 | Photosensitive | Support 2 | α5 | 5.4 | 0.25 | B154 | 3.11 |
| | member 11 | | | | | | |
| Example 12 | Photosensitive | Support 2 | α6 | 5.0 | 0.25 | B154 | 3.11 |
| | member 12 | | | | | | |
| Example 13 | Photosensitive | Support 4 | α1 | 5.2 | 0.25 | B154 | 3.11 |
| | member 13 | | | | | | |
| Example 14 | Photosensitive | Support 4 | α2 | 5.3 | 0.25 | B154 | 3.11 |
| | member 14 | | | | | | |
| Example 15 | Photosensitive | Support 4 | α3 | 5.1 | 0.25 | B154 | 3.11 |
| | member 15 | | | | | | |
| Example 16 | Photosensitive | Support 4 | α6 | 5.0 | 0.25 | B154 | 3.11 |
| | member 16 | | | | | | |
| Example 17 | Photosensitive | Support 2 | α1 | 5.2 | 0.25 | B153 | 3.11 |
| | member 17 | | | | | | |
| Example 18 | Photosensitive | Support 2 | α2 | 5.3 | 0.25 | B153 | 3.11 |
| | member 18 | | | | | | |
| Example 19 | Photosensitive | Support 2 | α3 | 5.1 | 0.25 | B153 | 3.11 |
| | member 19 | | | | | | |
| Example 20 | Photosensitive | Support 2 | α4 | 5.4 | 0.25 | B153 | 3.11 |
| | member 20 | | | | | | |
| Example 21 | Photosensitive | Support 2 | α5 | 5.4 | 0.25 | B153 | 3.11 |
| | member 21 | | | | | | |
| Example 22 | Photosensitive | Support 2 | α6 | 5.0 | 0.25 | B153 | 3.11 |
| | member 22 | | | | | | |
| Example 23 | Photosensitive | Support 2 | α1 | 5.2 | 0.25 | B101 | 3.11 |
| | member 23 | | | | | | |
| Example 24 | Photosensitive | Support 2 | α2 | 5.3 | 0.25 | B101 | 3.11 |
| | member 24 | | | | | | |
| Example 25 | Photosensitive | Support 2 | α3 | 5.1 | 0.25 | B101 | 3.11 |
| | member 25 | | | | | | |
| Example 26 | Photosensitive | Support 2 | α4 | 5.4 | 0.25 | B101 | 3.11 |
| | member 26 | | | | | | |
| Example 27 | Photosensitive | Support 2 | α5 | 5.4 | 0.25 | B101 | 3.11 |
| | member 27 | | | | | | |
| Example 28 | Photosensitive | Support 2 | α6 | 5.0 | 0.25 | B101 | 3.11 |
| | member 28 | | | | | | |
| Example 29 | Photosensitive | Support 2 | α1 | 5.2 | 0.25 | B224 | 3.11 |
| | member 29 | | | | | | |
| Example 30 | Photosensitive | Support 2 | α2 | 5.3 | 0.25 | B224 | 3.11 |
| | member 30 | | | | | | |
| Example 31 | Photosensitive | Support 2 | α3 | 5.1 | 0.25 | B224 | 3.11 |
| | member 31 | | | | | | |
| Example 32 | Photosensitive | Support 2 | α4 | 5.4 | 0.25 | B224 | 3.11 |
| | member 32 | | | | | | |
| Example 33 | Photosensitive | Support 2 | α5 | 5.4 | 0.25 | B224 | 3.11 |
| | member 33 | | | | | | |
| Example 34 | Photosensitive | Support 2 | α6 | 5.0 | 0.25 | B224 | 3.11 |
| | member 34 | | | | | | |
| Example 35 | Photosensitive | Support 4 | α1 | 5.2 | 0.25 | B224 | 3.11 |
| | member 35 | | | | | | |
| Example 36 | Photosensitive | Support 4 | α2 | 5.3 | 0.25 | B224 | 3.11 |
| | member 36 | | | | | | |
| Example 37 | Photosensitive | Support 4 | α3 | 5.1 | 0.25 | B224 | 3.11 |
| | member 37 | | | | | | |
| Example 38 | Photosensitive | Support 4 | α6 | 5.0 | 0.25 | B224 | 3.11 |
| | member 38 | | | | | | |

TABLE 3-1-2

| | Thickness of | Mass | | | | Fluctuation of | Residual |
|---|---|---|---|---|---|---|---|
| | undercoat | ratio | Ips | Ips − | Ipu | light portion | potential |
| Example | layer [μm] | α/B | [eV] | Ipα | [eV] | potential [V] | [V] |
| Example 1 | 1.8 | 0.080 | 5.7 | 0.5 | 6.1 | 0.5 | 32 |
| Example 2 | 1.8 | 0.080 | 5.7 | 0.4 | 6.1 | 0.8 | 35 |
| Example 3 | 1.8 | 0.080 | 5.7 | 0.6 | 6.1 | 0.6 | 33 |
| Example 4 | 1.8 | 0.080 | 5.7 | 0.3 | 6.1 | 0.9 | 35 |
| Example 5 | 1.8 | 0.080 | 5.7 | 0.3 | 6.1 | 0.9 | 36 |
| Example 6 | 1.8 | 0.080 | 5.7 | 0.7 | 6.1 | 0.6 | 33 |
| Example 7 | 1.8 | 0.080 | 5.6 | 0.4 | 6.1 | 0.6 | 32 |
| Example 8 | 1.8 | 0.080 | 5.6 | 0.3 | 6.1 | 0.9 | 33 |
| Example 9 | 1.8 | 0.080 | 5.6 | 0.5 | 6.1 | 0.7 | 32 |
| Example 10 | 1.8 | 0.080 | 5.6 | 0.2 | 6.1 | 3.2 | 45 |
| Example 11 | 1.8 | 0.080 | 5.6 | 0.2 | 6.1 | 3.1 | 42 |
| Example 12 | 1.8 | 0.080 | 5.6 | 0.6 | 6.1 | 0.6 | 33 |
| Example 13 | 1.8 | 0.080 | 4.3 | −0.9 | 6.1 | 5.1 | 52 |
| Example 14 | 1.8 | 0.080 | 4.3 | −1.0 | 6.1 | 5.3 | 53 |
| Example 15 | 1.8 | 0.080 | 4.3 | −0.8 | 6.1 | 5.4 | 53 |
| Example 16 | 1.8 | 0.080 | 4.3 | −0.7 | 6.1 | 5.2 | 55 |
| Example 17 | 1.8 | 0.080 | 5.6 | 0.4 | 6.1 | 0.6 | 32 |
| Example 18 | 1.8 | 0.080 | 5.6 | 0.3 | 6.1 | 0.8 | 33 |
| Example 19 | 1.8 | 0.080 | 5.6 | 0.5 | 6.1 | 0.8 | 31 |
| Example 20 | 1.8 | 0.080 | 5.6 | 0.2 | 6.1 | 3.2 | 41 |
| Example 21 | 1.8 | 0.080 | 5.6 | 0.2 | 6.1 | 3.5 | 44 |
| Example 22 | 1.8 | 0.080 | 5.6 | 0.6 | 6.1 | 0.5 | 33 |
| Example 23 | 1.8 | 0.080 | 5.6 | 0.4 | 6.1 | 0.9 | 32 |
| Example 24 | 1.8 | 0.080 | 5.6 | 0.3 | 6.1 | 0.8 | 33 |
| Example 25 | 1.8 | 0.080 | 5.6 | 0.5 | 6.1 | 0.8 | 31 |
| Example 26 | 1.8 | 0.080 | 5.6 | 0.2 | 6.1 | 3.6 | 43 |
| Example 27 | 1.8 | 0.080 | 5.6 | 0.2 | 6.1 | 3.1 | 43 |
| Example 28 | 1.8 | 0.080 | 5.6 | 0.6 | 6.1 | 0.6 | 31 |
| Example 29 | 1.8 | 0.080 | 5.6 | 0.4 | 6.2 | 0.6 | 32 |
| Example 30 | 1.8 | 0.080 | 5.6 | 0.3 | 6.2 | 0.5 | 35 |
| Example 31 | 1.8 | 0.080 | 5.6 | 0.5 | 6.2 | 0.5 | 33 |
| Example 32 | 1.8 | 0.080 | 5.6 | 0.2 | 6.2 | 3.5 | 44 |
| Example 33 | 1.8 | 0.080 | 5.6 | 0.2 | 6.2 | 3.7 | 40 |
| Example 34 | 1.8 | 0.080 | 5.6 | 0.6 | 6.2 | 0.7 | 33 |
| Example 35 | 1.8 | 0.080 | 4.3 | −0.9 | 6.2 | 5.5 | 53 |
| Example 36 | 1.8 | 0.080 | 4.3 | −1.0 | 6.2 | 5.2 | 52 |
| Example 37 | 1.8 | 0.080 | 4.3 | −0.8 | 6.2 | 5.4 | 54 |
| Example 38 | 1.8 | 0.080 | 4.3 | −0.7 | 6.2 | 5.3 | 54 |

TABLE 3-2-1

| | | | Compound (α) | | | Compound (B1) (B2) | |
|---|---|---|---|---|---|---|---|
| | | | | | Addition | | Addition |
| | Photosensitive | | | IPα | amount | Compound | amount |
| Example | member | Support | Compound | [eV] | [parts] | (B1) (B2) | [parts] |
| Example 39 | Photosensitive | Support 2 | α1 | 5.2 | 0.25 | B224 | 3.11 |
| | member 39 | | | | | | |
| Example 40 | Photosensitive | Support 2 | α2 | 5.3 | 0.25 | B224 | 3.11 |
| | member 40 | | | | | | |
| Example 41 | Photosensitive | Support 2 | α3 | 5.1 | 0.25 | B224 | 3.11 |
| | member 41 | | | | | | |
| Example 42 | Photosensitive | Support 2 | α4 | 5.4 | 0.25 | B224 | 3.11 |
| | member 42 | | | | | | |
| Example 43 | Photosensitive | Support 2 | α5 | 5.4 | 0.25 | B224 | 3.11 |
| | member 43 | | | | | | |
| Example 44 | Photosensitive | Support 2 | α6 | 5.0 | 0.25 | B224 | 3.11 |
| | member 44 | | | | | | |
| Example 45 | Photosensitive | Support 4 | α1 | 5.2 | 0.25 | B224 | 3.11 |
| | member 45 | | | | | | |
| Example 46 | Photosensitive | Support 4 | α2 | 5.3 | 0.25 | B224 | 3.11 |
| | member 46 | | | | | | |
| Example 47 | Photosensitive | Support 4 | α3 | 5.1 | 0.25 | B224 | 3.11 |
| | member 47 | | | | | | |
| Example 48 | Photosensitive | Support 4 | α6 | 5.0 | 0.25 | B224 | 3.11 |
| | member 48 | | | | | | |
| Example 49 | Photosensitive | Support 2 | α1 | 5.2 | 0.11 | B154 | 3.11 |
| | member 49 | | | | | | |
| Example 50 | Photosensitive | Support 2 | α2 | 5.3 | 0.11 | B154 | 3.11 |
| | member 50 | | | | | | |
| Example 51 | Photosensitive | Support 2 | α3 | 5.1 | 0.11 | B154 | 3.11 |
| | member 51 | | | | | | |
| Example 52 | Photosensitive | Support 2 | α4 | 5.4 | 0.11 | B154 | 3.11 |
| | member 52 | | | | | | |
| Example 53 | Photosensitive | Support 2 | α5 | 5.4 | 0.11 | B154 | 3.11 |
| | member 53 | | | | | | |
| Example 54 | Photosensitive | Support 2 | α6 | 5.0 | 0.11 | B154 | 3.11 |
| | member 54 | | | | | | |
| Example 55 | Photosensitive | Support 2 | α1 | 5.2 | 0.46 | B154 | 3.11 |
| | member 55 | | | | | | |
| Example 56 | Photosensitive | Support 2 | α2 | 5.3 | 0.46 | B154 | 3.11 |
| | member 56 | | | | | | |
| Example 57 | Photosensitive | Support 2 | α3 | 5.1 | 0.46 | B154 | 3.11 |
| | member 57 | | | | | | |
| Example 58 | Photosensitive | Support 2 | α4 | 5.4 | 0.46 | B154 | 3.11 |
| | member 58 | | | | | | |
| Example 59 | Photosensitive | Support 2 | α5 | 5.4 | 0.46 | B154 | 3.11 |
| | member 59 | | | | | | |
| Example 60 | Photosensitive | Support 2 | α6 | 5.0 | 0.46 | B154 | 3.11 |
| | member 60 | | | | | | |
| Example 61 | Photosensitive | Support 2 | α1 | 5.2 | 0.16 | B225 | 3.11 |
| | member 61 | | | | | | |
| Example 62 | Photosensitive | Support 2 | α1 | 5.2 | 0.16 | B225 | 3.11 |
| | member 62 | | | | | | |
| Example 63 | Photosensitive | Support 2 | α1 | 5.2 | 0.16 | B225 | 3.11 |
| | member 63 | | | | | | |
| Example 64 | Photosensitive | Support 2 | α1 | 5.2 | 0.25 | B154 | 3.11 |
| | member 64 | | | | | | |
| Example 65 | Photosensitive | Support 2 | α2 | 5.3 | 0.25 | B154 | 3.11 |
| | member 65 | | | | | | |
| Example 66 | Photosensitive | Support 2 | α3 | 5.1 | 0.25 | B154 | 3.11 |
| | member 66 | | | | | | |
| Example 67 | Photosensitive | Support 2 | α4 | 5.4 | 0.25 | B154 | 3.11 |
| | member 67 | | | | | | |
| Example 68 | Photosensitive | Support 2 | α5 | 5.4 | 0.25 | B154 | 3.11 |
| | member 68 | | | | | | |
| Example 69 | Photosensitive | Support 2 | α6 | 5.0 | 0.25 | B154 | 3.11 |
| | member 69 | | | | | | |
| Example 70 | Photosensitive | Support 2 | α6 | 5.0 | 0.46 | B101 | 3.11 |
| | member 70 | | | | | | |
| Example 71 | Photosensitive | Support 2 | α1 | 5.2 | 0.25 | B154 | 3.11 |
| | member 71 | | | | | | |
| Example 72 | Photosensitive | Support 2 | α2 | 5.3 | 0.25 | B154 | 3.11 |
| | member 72 | | | | | | |
| Example 73 | Photosensitive | Support 2 | α3 | 5.1 | 0.25 | B154 | 3.11 |
| | member 73 | | | | | | |
| Example 74 | Photosensitive | Support 3 | α1 | 5.2 | 0.25 | B154 | 3.11 |
| | member 74 | | | | | | |
| Example 75 | Photosensitive | Support 3 | α2 | 5.3 | 0.25 | B154 | 3.11 |
| | member 75 | | | | | | |
| Example 76 | Photosensitive | Support 3 | α3 | 5.1 | 0.25 | B154 | 3.11 |
| | member 76 | | | | | | |

TABLE 3-2-2

| | Thickness of | Mass | | | | Fluctuation of | Residual |
|---|---|---|---|---|---|---|---|
| | undercoat | ratio | | Ips − | | light portion | potential |
| Example | layer [μm] | α/B | IPs[eV] | Ipx | IPu[eV] | potential [V] | [V] |
| Example 39 | 1.8 | 0.080 | 5.6 | 0.4 | 6.1 | 0.6 | 33 |
| Example 40 | 1.8 | 0.080 | 5.6 | 0.3 | 6.1 | 0.5 | 35 |
| Example 41 | 1.8 | 0.080 | 5.6 | 0.5 | 6.1 | 0.8 | 31 |
| Example 42 | 1.8 | 0.080 | 5.6 | 0.2 | 6.1 | 3.8 | 44 |
| Example 43 | 1.8 | 0.080 | 5.6 | 0.2 | 6.1 | 4 | 42 |
| Example 44 | 1.8 | 0.080 | 5.6 | 0.6 | 6.1 | 4 | 33 |
| Example 45 | 1.8 | 0.080 | 4.3 | −0.9 | 6.1 | 5.2 | 55 |
| Example 46 | 1.8 | 0.080 | 4.3 | −1.0 | 6.1 | 5.3 | 52 |
| Example 47 | 1.8 | 0.080 | 4.3 | −0.8 | 6.1 | 5.4 | 54 |
| Example 48 | 1.8 | 0.080 | 4.3 | −0.7 | 6.1 | 5.1 | 53 |
| Example 49 | 1.8 | 0.035 | 5.6 | 0.4 | 6.1 | 0.6 | 32 |
| Example 50 | 1.8 | 0.035 | 5.6 | 0.3 | 6.1 | 0.7 | 32 |
| Example 51 | 1.8 | 0.035 | 5.6 | 0.5 | 6.1 | 0.5 | 33 |
| Example 52 | 1.8 | 0.035 | 5.6 | 0.2 | 6.1 | 3.5 | 44 |
| Example 53 | 1.8 | 0.035 | 5.6 | 0.2 | 6.1 | 3.6 | 44 |
| Example 54 | 1.8 | 0.035 | 5.6 | 0.6 | 6.1 | 0.7 | 31 |
| Example 55 | 1.8 | 0.148 | 5.6 | 0.4 | 6.1 | 0.6 | 32 |
| Example 56 | 1.8 | 0.148 | 5.6 | 0.3 | 6.1 | 0.5 | 31 |
| Example 57 | 1.8 | 0.148 | 5.6 | 0.5 | 6.1 | 0.5 | 35 |
| Example 58 | 1.8 | 0.148 | 5.6 | 0.2 | 6.1 | 3.5 | 44 |
| Example 59 | 1.8 | 0.148 | 5.6 | 0.2 | 6.1 | 3.7 | 43 |
| Example 60 | 1.8 | 0.148 | 5.6 | 0.6 | 6.1 | 0.8 | 31 |
| Example 61 | 1.8 | 0.051 | 5.6 | 0.4 | 6.3 | 0.7 | 32 |
| Example 62 | 1.8 | 0.051 | 5.6 | 0.4 | 6.3 | 0.9 | 32 |
| Example 63 | 1.8 | 0.051 | 5.6 | 0.4 | 6.3 | 0.7 | 32 |
| Example 64 | 2.4 | 0.080 | 5.6 | 0.4 | 6.1 | 0.8 | 35 |
| Example 65 | 2.4 | 0.080 | 5.6 | 0.3 | 6.1 | 0.9 | 34 |
| Example 66 | 2.4 | 0.080 | 5.6 | 0.5 | 6.1 | 0.8 | 35 |
| Example 67 | 2.4 | 0.080 | 5.6 | 0.2 | 6.1 | 3.5 | 45 |
| Example 68 | 2.4 | 0.080 | 5.6 | 0.2 | 6.1 | 3.2 | 45 |
| Example 69 | 2.4 | 0.080 | 5.6 | 0.6 | 6.1 | 0.8 | 35 |
| Example 70 | 2.4 | 0.148 | 5.6 | 0.6 | 6.0 | 0.9 | 34 |
| Example 71 | 0.5 | 0.080 | 5.6 | 0.4 | 6.1 | 0.9 | 34 |
| Example 72 | 0.5 | 0.080 | 5.6 | 0.3 | 6.1 | 0.7 | 34 |
| Example 73 | 0.5 | 0.080 | 5.6 | 0.5 | 6.1 | 0.8 | 35 |
| Example 74 | 1.8 | 0.080 | 5.8 | 0.6 | 6.1 | 0.5 | 33 |
| Example 75 | 1.8 | 0.080 | 5.8 | 0.5 | 6.1 | 0.9 | 34 |
| Example 76 | 1.8 | 0.080 | 5.8 | 0.7 | 6.1 | 0.5 | 33 |

### (Manufacturing Example of Electrophotographic Photosensitive Member 101)

A cylindrical aluminum substrate having a length of 370 mm and a diameter of 30.5 mm was used as a support.

An electrophotographic photosensitive member was manufactured in the same way as in the manufacturing example of the photosensitive member 1, except that the compound (α1) was not added to the support and the coating liquid for the undercoat layer as shown in Table 4-1-1 and Table 4-1-2. The obtained electrophotographic photosensitive member shall be designated as a photosensitive member 101.

### (Manufacturing Example of Photosensitive Member 102)

An aluminum cylinder (JIS-A3003, aluminum alloy) was used as a support (electroconductive support), which had a length of 370 mm and a diameter of 30.5 mm. Next, 19.5 parts of blocked isocyanate (Sumidur BL3175, produced by Sumika Covestro Urethane Co., Ltd., solid fraction 75% by mass) and 7.5 parts of a butyral resin (S-LEC BL-1, produced by Sekisui Chemical Co., Ltd.) were dissolved in 130 parts of methyl ethyl ketone. Next, 34 parts of Pigment Orange 43 (produced by Tokyo Chemical Industry Co., Ltd.) and 0.9 parts of Comparative Example compound 1 were mixed with the above dissolved liquid, then, the mixture was dispersed in a sand mill for 10 hours, and a dispersion liquid was obtained. To the dispersion liquid, 0.005 parts of bismuth carboxylate (K-KATXK-640, produced by King Industries Inc.) was added, and a coating liquid for an undercoat layer was obtained. The coating liquid for the undercoat layer was applied onto the support by dip coating, the obtained coating film was cured at 160° C. for 60 minutes, and an undercoat layer was obtained which had a thickness of 7 μm. All the layers above the undercoat layer were formed in the same way as in the manufacturing example of the photosensitive member 1, and an electrophotographic photosensitive member was manufactured. The obtained electrophotographic photosensitive member shall be designated as a photosensitive member 102.

### (Manufacturing Example of Photosensitive Members 103 to 104)

Electrophotographic photosensitive members were manufactured in the same way as in the photosensitive member 102, except that forming conditions of the undercoat layers were changed as described in Table 4-1-1 and Table 4-1-2. The obtained photosensitive members shall be designated as photosensitive members 103 to 104.

### (Manufacturing Example of Photosensitive Member 105)

An electrophotographic photosensitive member was manufactured in the same way as in the photosensitive member 1, except that the support described in Table 4-1-1 was used and forming conditions of the undercoat layer were changed as described in Table 4-1-1 and Table 4-1-2. The obtained photosensitive member shall be designated as a photosensitive member 105.

### (Manufacturing Example of Photosensitive Member 106)

Firstly, 46.7 parts of blocked isocyanate (Sumidur BL3175, produced by Sumika Covestro Urethane Co., Ltd., solid fraction 75% by mass) as a curing agent and 5 parts of a triarylamine compound having a reactive group (Comparative Example compound 10) were dissolved in 100 parts of methyl ethyl ketone and 100 parts by mass of cyclopentanone. To this solution, 60 parts of Pigment Orange 43 (produced by Tokyo Chemical Industry Co., Ltd.) was mixed, and the mixture was dispersed for 4 hours in a sand mill with the use of glass beads; and to the obtained dispersion liquid, 0.001 parts of bismuth carboxylate (produced by King Industries Inc.) was added as a catalyst, and a coating liquid for an undercoat layer was obtained. The coating liquid was applied onto a cylindrical aluminum support shown in Table 4-1-1 by dip coating, the coating film was dried and cured at 160° C. for 45 minutes, and an undercoat layer was formed which had a film thickness of 4.2 μm. All the layers above the undercoat layer were formed in the same way as in the manufacturing example of the photosensitive member 1, and an electrophotographic photosensitive member was manufactured. The obtained electrophotographic photosensitive member shall be designated as a photosensitive member 106.

### (Manufacturing Example of Photosensitive Member 107)

Firstly, 40 parts of blocked isocyanate (Sumidur BL3175, produced by Sumika Covestro Urethane Co., Ltd., solid fraction 75% by mass) as a curing agent, 5 parts of a triarylamine compound having a reactive group (Comparative Example compound 15), and 5 parts of a butyral resin (S-LEC BL-1, produced by Sekisui Chemical Co., Ltd.) were dissolved in 100 parts of methyl ethyl ketone and 100 parts by mass of cyclopentanone. To this solution, 60 parts of Pigment Orange 43 (produced by Tokyo Chemical Industry Co., Ltd.) was mixed, and the mixture was dispersed for 4 hours in a sand mill with the use of glass beads; and to the obtained dispersion liquid, 0.001 parts of bismuth carboxylate (produced by King Industries Inc.) was added as a catalyst, and a coating liquid for an undercoat layer was obtained. The coating liquid was applied onto a cylindrical aluminum support shown in Table 4-1-1 by dip coating, the coating film was dried and cured at 160° C. for 45 minutes, and an undercoat layer was formed which had a film thickness of 4.2 μm.

All the layers above the undercoat layer were formed in the same way as in the manufacturing example of the photosensitive member 1, and an electrophotographic photosensitive member was manufactured. The obtained electrophotographic photosensitive member shall be designated as a photosensitive member 107.

### (Manufacturing Example of Photosensitive Member 108)

Firstly, 40 parts of blocked isocyanate (Sumidur BL3175, produced by Sumika Covestro Urethane Co., Ltd., solid fraction 75% by mass) as a curing agent, 5 parts of a triarylamine compound having a reactive group (Comparative Example compound 15), and 5 parts of a butyral resin (S-LEC BL-1, produced by Sekisui Chemical Co., Ltd.) were dissolved in 100 parts of methyl ethyl ketone and 100 parts by mass of cyclopentanone. To this solution, 60 parts of Pigment Orange 43 (produced by Tokyo Chemical Industry Co., Ltd.) was mixed, and the mixture was dispersed for 4 hours in a sand mill with the use of glass beads; and to the obtained dispersion liquid, 0.001 parts of bismuth carboxylate (produced by King Industries Inc.) was added as a catalyst, and a coating liquid for an undercoat layer was obtained. The coating liquid was applied onto a cylindrical aluminum support shown in Table 4-1-1 by dip coating, the coating film was dried and cured at 160° C. for 45 minutes, and an undercoat layer was formed which had a film thickness of 1.8 μm.

All the layers above the undercoat layer were formed in the same way as in the manufacturing example of the photosensitive member 1, and an electrophotographic photosensitive member was manufactured. The obtained electrophotographic photosensitive member shall be designated as a photosensitive member 108.

TABLE 4-1-1

| | | | Compound (α) | | | Compound (B1) (B2) | |
|---|---|---|---|---|---|---|---|
| | | | | | Addition | | Addition |
| | Photosensitive | | | Ipα | amount | Compound | amount |
| Example | member | Support | Compound | [eV] | [parts] | (B1) (B2) | [parts] |
| Comparative | Photosensitive | Support made from | — | — | — | B154 | 3.11 |
| Example 1 | member 101 | aluminum | | | | | |
| Comparative | Photosensitive | Support made from | Comparative | 5.8 | 0.9 | Pigment | 34 |
| Example 2 | member 102 | aluminum | Example | | | orange 43 | |
| | | | Compound 1 | | | | |
| Comparative | Photosensitive | Support made from | Comparative | 5.7 | 3 | Pigment | 34 |
| Example 3 | member 103 | aluminum | Example | | | orange 43 | |
| | | | Compound 2 | | | | |
| Comparative | Photosensitive | Support made from | Comparative | 5.6 | 3 | Pigment | 34 |
| Example 4 | member 104 | aluminum | Example | | | orange 43 | |
| | | | Compound 9 | | | | |
| Comparative | Photosensitive | Support made from | α4 | 5.4 | 0.25 | B154 | 3.11 |
| Example 5 | member 105 | aluminum | | | | | |
| Comparative | Photosensitive | Support made from | Comparative | 5.5 | 5 | Pigment | 60 |
| Example 6 | member 106 | aluminum | Example | | | orange 43 | |
| | | | Compound 10 | | | | |
| Comparative | Photosensitive | Support made from | Comparative | 4.8 | 5 | Pigment | 60 |
| Example 7 | member 107 | aluminum | Example | | | orange 43 | |
| | | | Compound 15 | | | | |
| Comparative | Photosensitive | Support made from | Comparative | 4.8 | 5 | Pigment | 60 |
| Example 8 | member 108 | aluminum | Example | | | orange 43 | |
| | | | Compound 15 | | | | |

TABLE 4-1-2

| | Thickness of | Mass | | | | Fluctuation of | Residual |
|---|---|---|---|---|---|---|---|
| | undercoat layer | ratio | Ips | Ips − | Ipu | light portion | potential |
| Example | [μm] | α/B | [eV] | Ipα | [eV] | potential [V] | [V] |
| Comparative | 1 | — | 4.2 | − | 6.1 | 7.2 | 65 |
| Example 1 | | | | | | | |
| Comparative | 7 | 0.026 | 4.2 | −1.6 | 6.2 | 8.5 | 79 |
| Example 2 | | | | | | | |
| Comparative | 7 | 0.088 | 4.2 | −1.5 | 6.2 | 8.8 | 80 |
| Example 3 | | | | | | | |
| Comparative | 7 | 0.088 | 4.2 | −1.4 | 6.2 | 8.2 | 75 |
| Example 4 | | | | | | | |
| Comparative | 1 | 0.080 | 4.2 | −1.2 | 6.1 | 7.5 | 63 |
| Example 5 | | | | | | | |
| Comparative | 4.2 | 0.083 | 4.2 | −1.3 | 6.2 | 8.3 | 76 |
| Example 6 | | | | | | | |
| Comparative | 4.2 | 0.083 | 4.2 | −0.6 | 6.2 | 7 | 34 |
| Example 7 | | | | | | | |
| Comparative | 1.8 | 0.083 | 4.2 | −0.6 | 6.2 | 7.2 | 33 |
| Example 8 | | | | | | | |

TABLE 5-1

| Compound | Structure | Ionization potential [eV] |
|---|---|---|
| Comparative Example Compound 1 | 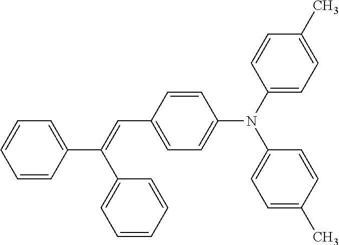 [SMILES: Cc1ccc(N(c2ccc(C)cc2)c2ccc(C=C(c3ccccc3)c3ccccc3)cc2)cc1] | 5.9 |
| Comparative Example Compound 2 | 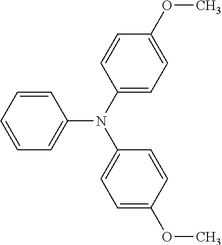 [SMILES: COc1ccc(N(c2ccccc2)c2ccc(OC)cc2)cc1] | 5.7 |
| Comparative Example Compound 3 | 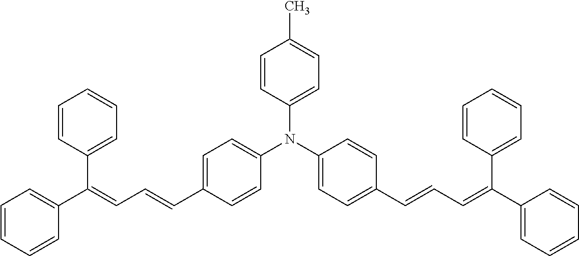 [SMILES: Cc1ccc(N(c2ccc(/C=C/C=C(c3ccccc3)c3ccccc3)cc2)c2ccc(/C=C/C=C(c3ccccc3)c3ccccc3)cc2)cc1] | 5.8 |
| Comparative Example Compound 4 | 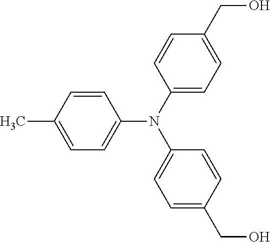 [SMILES: Cc1ccc(N(c2ccc(CO)cc2)c2ccc(CO)cc2)cc1] | 5.8 |
| Comparative Example Compound 5 | 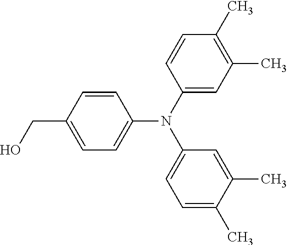 [SMILES: Cc1ccc(N(c2ccc(CO)cc2)c2ccc(C)c(C)c2)cc1C] | 5.9 |
| Comparative Example Compound 6 | 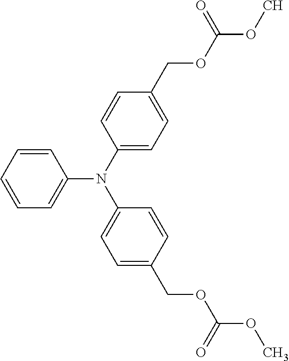 [SMILES: COC(=O)OCc1ccc(N(c2ccccc2)c2ccc(COC(=O)OC)cc2)cc1] | 6.0 |
| Comparative Example Compound 7 | 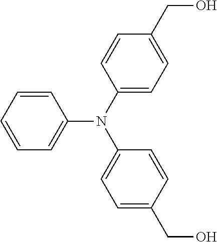 [SMILES: OCc1ccc(N(c2ccccc2)c2ccc(CO)cc2)cc1] | 6.1 |
| Comparative Example Compound 8 | 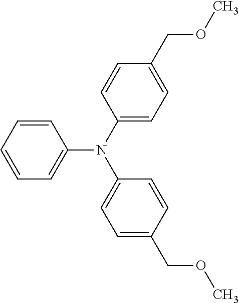 [SMILES: COCc1ccc(N(c2ccccc2)c2ccc(COC)cc2)cc1] | 6.1 |
| Comparative Example Compound 9 | 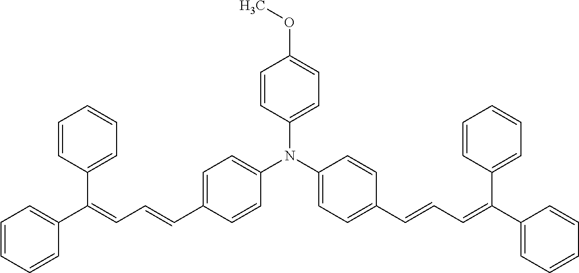 [SMILES: COc1ccc(N(c2ccc(/C=C/C=C(c3ccccc3)c3ccccc3)cc2)c2ccc(/C=C/C=C(c3ccccc3)c3ccccc3)cc2)cc1] | 5.6 |

TABLE 5-2

| | | Ionization |
|---|---|---|
| Compound | Structure | potential [eV] |
| Comparative Example Compound 10 | 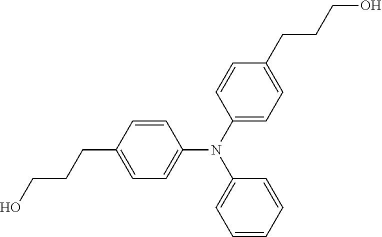 [SMILES: OCCCc1ccc(N(c2ccccc2)c2ccc(CCCO)cc2)cc1] | 5.5 |
| Comparative Example Compound 11 | 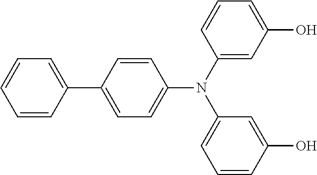 [SMILES: Oc1cccc(N(c2ccc(-c3ccccc3)cc2)c2cccc(O)c2)c1] | 5.8 |
| Comparative Example Compound 12 | 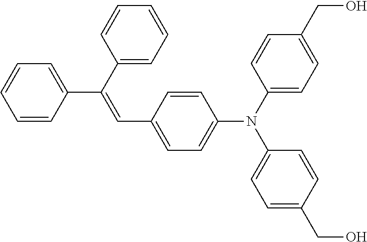 [SMILES: OCc1ccc(N(c2ccc(C=C(c3ccccc3)c3ccccc3)cc2)c2ccc(CO)cc2)cc1] | 6.0 |
| Comparative Example Compound 13 | 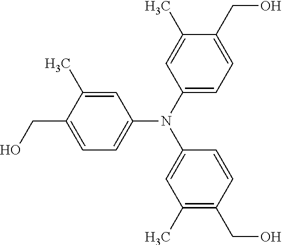 [SMILES: Cc1cc(N(c2ccc(CO)c(C)c2)c2ccc(CO)c(C)c2)ccc1CO] | 6.0 |
| Comparative Example Compound 14 | 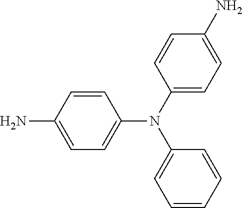 [SMILES: Nc1ccc(N(c2ccccc2)c2ccc(N)cc2)cc1] | 4.8 |
| Comparative Example Compound 15 | 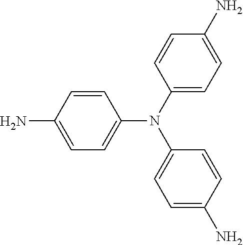 [SMILES: Nc1ccc(N(c2ccc(N)cc2)c2ccc(N)cc2)cc1] | 4.8 |
| Comparative Example Compound 16 | 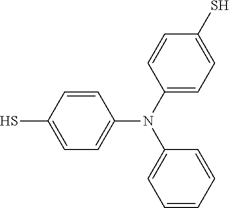 [SMILES: Sc1ccc(N(c2ccccc2)c2ccc(S)cc2)cc1] | 6.1 |
| Comparative Example Compound 17 | 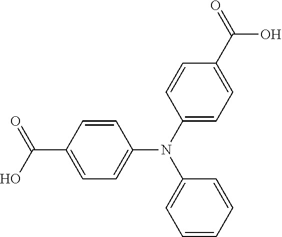 [SMILES: O=C(O)c1ccc(N(c2ccccc2)c2ccc(C(=O)O)cc2)cc1] | 5.8 |
| Comparative Example Compound 18 | 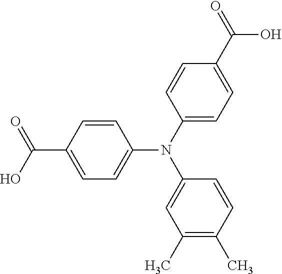 [SMILES: Cc1ccc(N(c2ccc(C(=O)O)cc2)c2ccc(C(=O)O)cc2)cc1C] | 5.7 |
| Comparative Example Compound 19 | 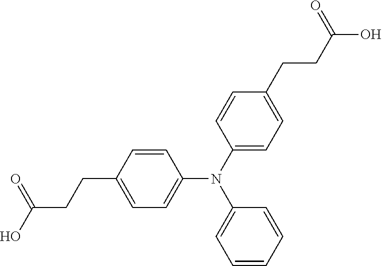 [SMILES: O=C(O)CCc1ccc(N(c2ccccc2)c2ccc(CCC(=O)O)cc2)cc1] | 5.6 |

### Evaluation

### Examples 1 to 76 and Comparative Examples 1 to 8

The photosensitive member 1 was prepared, was mounted on a cyan station of an electrophotographic apparatus (copying machine) (trade name: image PRESSC 910, manufactured by Canon Inc.) which was an evaluation apparatus, and was evaluated in the following way.

A surface potential of the electrophotographic photosensitive member was measured by extracting a developing cartridge from the evaluation apparatus, setting a potential probe (trade name: model 6000B-8, manufactured by Midoriya Electric Co., Ltd.) there, and using a surface potential meter (model 344: manufactured by Midoriya Electric Co., Ltd.).

The dark portion potential (Vd) and the light portion potential (Vl) were measured at 12 points at intervals of 30° in the circumferential direction at the center position in the axial direction of the electrophotographic photosensitive member, and average values of one rotation were calculated as respective numerical values.

Firstly, a voltage which was applied to the charging roller was adjusted so that the dark potential (Vd) of the first sheet of A4 paper in the electrophotographic photosensitive member to be used for evaluation became-680 V under an environment of 30° C./80% RH. Next, an amount of image exposure light was adjusted so that the light portion potential (Vl) of the first sheet of A4 paper became-380 V.

After 3 hours, 200 sheets of paper were passed under the environment of 30° C./80% RH, at the voltage applied to the charging roller, which was set so that the dark portion potential (Vd) became-680 V, and the amount of the exposure light which was set so that the light portion potential (Vl) became-380 V, and the light portion potential (Vl) during that period was measured.

The light portion potentials of the first sheet and the 200th sheet were calculated by the above method, an absolute value of (initial light portion potential-light portion potential after 200 sheets of paper were passed) was calculated, and the value was calculated as a short-term potential fluctuation value. The evaluation results are shown in Table 3-1-2, Table 3-2-2, and Table 4-1-2.

The residual potential was measured by starting the measurement at the time when the electrophotographic photosensitive member rotated one lap from a position at which the charging was cut after the light portion potential was measured after 200 sheets of paper were passed, and then measuring the potential in one rotation of the electrophotographic photosensitive member. In addition, the residual potential was measured also at 12 points at intervals of 30° in the circumferential direction, as in the measurement of the light portion potential. After that, an average value in one rotation of the electrophotographic photosensitive member was calculated and was determined to be the residual potential.

The obtained evaluation results are shown in Table 3-1-2, Table 3-2-2, and Table 4-1-2.

The ionization potentials of the support, the undercoat layer, the compound (α), and the Comparative Example compound were measured with the use of AC-3 (manufactured by Riken Keiki Co., Ltd.). The ionization potentials for the compound (α) and the Comparative Example compound were measured for the respective single substances. In addition, the ionization potentials were measured concerning the support, from the surface of the obtained support, and concerning the undercoat layer, from the surface of the undercoat layer after the undercoat layer was formed. The starting energy was set at 4.00 eV, the ending energy was set at 7.00 eV, and the step was set at 0.05 eV. The evaluation results are shown in Table 3-1-1, Table 3-1-2, Table 3-2-1, Table 3-2-2, Table 4-1-1, and Table 4-1-2.

The residual potential and the ionization potential of the undercoat layer were determined in the same way, except that the above photosensitive member 1 was replaced with the photosensitive members 2 to 76 and the photosensitive members 101 to 108. The obtained evaluation results are shown in Table 3-1-1, Table 3-1-2, Table 3-2-1, Table 3-2-2, Table 4-1-1, and Table 4-1-2.

According to the present disclosure, an electrophotographic photosensitive member can be provided that has a low residual potential and a small fluctuation in the light portion potential.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-183415, filed Oct. 25, 2023, which is hereby incorporated by reference herein in its entirety.

What is claimed is:

1. An electrophotographic photosensitive member comprising:
a support, an undercoat layer formed directly on the support, and a photosensitive layer formed on the undercoat layer, wherein
when an ionization potential of the undercoat layer is represented by IPu, the IPu is 6.0 eV or higher,
when an ionization potential of the support is represented by IPs, the IPs is lower than the IPu,
the undercoat layer contains a compound (α),
when an ionization potential of the compound (α) is represented by IPα, the IPα is 5.0 eV or higher and 5.4 eV or lower, and
the IPs and the IPα satisfy the following relational expression (1):
$$IPs \geq IP α - 1. . \qquad ( 1 )$$

2. The electrophotographic photosensitive member according to claim 1, wherein the IPs and the IPα satisfy the following relational expression (2):
$$IPs \geq IP α . \qquad ( 2 )$$

3. The electrophotographic photosensitive member according to claim 2, wherein the IPs and the IPα satisfy the following relational expression (3):
$$IPs - IP α \geq 0.3 . \qquad ( 3 )$$

4. The electrophotographic photosensitive member according to claim 1, wherein the compound (α) is a compound represented by the following formula (α): 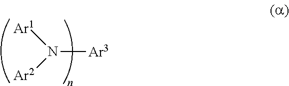
wherein Ar¹ and Ar² each independently represent a substituted or unsubstituted phenyl group; Ar³ represents an n-valent aromatic group, and n is an integer of 1 or more and 3 or less; and a substituent of the substituted phenyl group is an alkyl group or an alkoxy group.

5. The electrophotographic photosensitive member according to claim 1, wherein the undercoat layer contains a cured product of a composition containing a compound represented by the following formula (B1) or (B2): 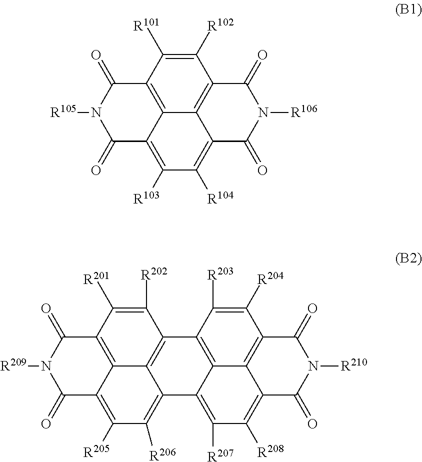
wherein R¹⁰¹ to R¹⁰⁶ and R²⁰¹ to R²¹⁰ each independently represent a monovalent group represented by the following formula (C), a hydrogen atom, a cyano group, a nitro group, a halogen atom, an alkoxycarbonyl group, a substituted or unsubstituted alkyl group, a substituted or unsubstituted aryl group, and a substituted or unsubstituted heterocyclic group, provided that at least one of R¹⁰¹ to R¹⁰⁶ and at least one of R²⁰¹ to R²¹⁰ are monovalent groups represented by the following formula (C); one of the CH₂ of the alkyl group is optionally substituted with O or S, or one of the CH of the alkyl group is optionally substituted with N; a substituent of the substituted alkyl group is at least one group selected from the group consisting of an aryl group, an alkoxycarbonyl group, a halogen atom, and a hydroxy group; and a substituent of the substituted aryl group and the substituted heterocyclic group is at least one group selected from the group consisting of a halogen atom, a nitro group, a cyano group, an alkyl group, a halogen group-substituted alkyl group, and an alkoxy group, 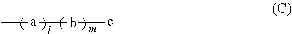
wherein at least one of a, b, and c has at least one group selected from the group consisting of a hydroxy group, a thiol group, an amino group, and a carboxy group; and 1 and m are each independently 0 or 1, and the sum of 1 and m is 0 or more and 2 or less;
a represents an alkylene group having 1 or more and 6 or less carbon atoms in the main chain, an alkylene group having 1 or more and 6 or less carbon atoms in the main chain substituted with an alkyl group having 1 or more and 6 or less carbon atoms, an alkylene group having 1 or more and 6 or less carbon atoms in the main chain substituted with a benzyl group, an alkylene group having 1 or more and 6 or less carbon atoms in the main chain substituted with an alkoxycarbonyl group, or an alkylene group having 1 or more and 6 or less carbon atoms in the main chain substituted with a phenyl group, wherein these alkylene groups optionally have at least one group as a substituent selected from the group consisting of a hydroxy group, a thiol group, an amino group, and a carboxy group; one of the CH₂ in the main chain of each of these alkylene groups is optionally substituted with O or S, or one of the CH in the main chain of each of these alkylene groups is optionally substituted with N;
b represents a phenylene group, a phenylene group substituted with an alkyl group having 1 or more and 6 or less carbon atoms, a phenylene group substituted with a nitro group, a phenylene group substituted with a halogen group, or a phenylene group substituted with an alkoxy group, wherein these phenylene groups optionally have at least one group as a substituent selected from the group consisting of a hydroxy group, a thiol group, an amino group, and a carboxy group; and
c represents a hydrogen atom, a carboxyl group, an alkyl group having 1 or more and 6 or less carbon atoms in the main chain, an alkyl group having 1 or more and 6 or less carbon atoms in the main chain substituted with an alkyl group having 1 or more and 5 or less carbon atoms, wherein these alkyl groups optionally have at least one group as a substituent selected from the group consisting of a hydroxy group, a thiol group, an amino group, and a carboxy group.

6. The electrophotographic photosensitive member according to claim 5, wherein a content of the compound (α) is 3.5% by mass or more and 15% by mass or less with respect to the compound represented by the formula (B1) or (B2).

7. A process cartridge comprising:
an electrophotographic photosensitive member including a support, an undercoat layer formed directly on the support, and a photosensitive layer formed on the undercoat layer; and
at least one unit selected from the group consisting of a charging unit, a developing unit and a cleaning unit, the process cartridge being detachably attachable to a main body of an electrophotographic apparatus,
wherein
when an ionization potential of the undercoat layer is represented by IPu, the IPu is 6.0 eV or higher,
when an ionization potential of the support is represented by IPs, the IPs is lower than the IPu,
the undercoat layer contains a compound (α),
when an ionization potential of the compound (α) is represented by IPα, the IPα is 5.0 eV or higher and 5.4 eV or lower, and
the IPs and the IPα satisfy the following relational expression (1):
$$IPs \geq IP α - 1. . \qquad ( 1 )$$

8. An electrophotographic apparatus comprising:
an electrophotographic photosensitive member including a support, an undercoat layer formed directly on the support, and a photosensitive layer formed on the undercoat layer; and
a charging unit, an exposure unit, a developing unit, and a transfer unit,
wherein
when an ionization potential of the undercoat layer is represented by IPu, the IPu is 6.0 eV or higher,
when an ionization potential of the support is represented by IPs, the IPs is lower than the IPu,
the undercoat layer contains a compound (α),
when an ionization potential of the compound (α) is represented by IPα, the IPα is 5.0 eV or higher and 5.4 eV or lower, and
the IPs and the IPα satisfy the following relational expression (1):
$$IPs \geq IP α - 1. . \qquad ( 1 )$$
